(19) United States
(12) Patent Application Publication
(10) Pub. No.: US 2025/0246902 A1
(43) Pub. Date: Jul. 31, 2025

(54) CONVOLUTIONAL NEURAL NETWORK MODEL-BASED ARC FAULT CIRCUIT INTERRUPTER

(71) Applicant: The University of North Carolina at Charlotte, Charlotte, NC (US)

(72) Inventors: Tiefu ZHAO, Charlotte, NC (US); Kamal Chandra PAUL, Monroe, NC (US); Shen En CHEN, Charlotte, NC (US)

(21) Appl. No.: 19/041,726

(22) Filed: Jan. 30, 2025

Related U.S. Application Data
(60) Provisional application No. 63/626,673, filed on Jan. 30, 2024.

(51) Int. Cl. H02H 9/02; G06N 3/0464

(52) U.S. Cl. CPC H02H 9/025; G06N 3/0464

(57) ABSTRACT

An apparatus includes a solid state circuit breaker selectively configured as a closed switch or an open switch. A current sensor is coupled to a current path passing through the closed switch and configured to sense an electrical current flowing on the current path while the switch is closed. A student convolutional neural network (CNN) model is pretrained using a knowledge distillation-based teacher-student approach. The student CNN model is coupled to the solid state circuit breaker and the current sensor and configured to process data representative of the electrical current, the data being processed cyclically with a period defined by an arc fault detection cycle. According to some aspects, in response to the student CNN model detecting, in association with the electrical current, an arc fault lasting a predetermined number of consecutive arc fault detection cycles, the solid state circuit breaker is reconfigured as the open switch.

### CROSS-REFERENCE TO RELATED APPLICATIONS

This application for patent claims priority to and the benefit of provisional patent application No. 63/626,673 entitled “Lightweight Neural Network-Based Series DC Arc Fault Circuit Interrupter for PV Systems” filed in the United States Patent and Trademark Office on Jan. 30, 2024, the entire content of which is incorporated herein by reference as if fully set forth below in its entirety and for all applicable purposes.

### TECHNICAL FIELD

This disclosure relates generally to arc fault circuit interrupters, and more specifically, to student convolutional neural network model-based arc fault circuit interrupters.

### INTRODUCTION

Photovoltaic systems are rapidly emerging in the power system market because of the widespread concerns of environmental pollution, global warming, and the eventual quest for a cleaner and renewable energy resource. Photovoltaic systems use solar energy to produce clean energy which is very convenient to use. It also plays a vital role in distributed generation systems. They are widely used for commercial and household needs. By 2050, it is expected that solar power would be the largest source of electricity in the world supplying about 11% of global power consumption. However, various reasons, such as improper installation of the photovoltaic system, loose cable connection, insulation breakdown due to aging, and pinching of the cable by accident may lead to arc faults in the photovoltaic systems and the reliability is seriously affected. Arc fault in a photovoltaic system can generate a high temperature ranging from 5000 to 15000 Celsius at the center of the arc which produces high ionized gas pressure, torch combustible materials, and causes electrical fire hazards.

An arc fault is stochastic in nature and can happen anywhere in the PV system. Series arcs also, sometimes, are masked by the noise of the load. The output voltage and current signals of the photovoltaic system are mixed with various noise components from different sources including radio frequency interference, power electronics noise such as inverter switching frequency, electromagnetic interference (EMI), and noise due to changes in solar irradiance, temperature, and load conditions. These noises distort the arc signals. These conditions make the detection of series direct current (DC) arc faults in photovoltaic systems challenging. Yet arch faults should be detected and stopped because arc faults adversely affect the reliability of the photovoltaic system.

There are two types of arc faults: series arc fault and parallel arc fault. A parallel arc fault is associated with a high current, like a short circuit current, which is easily identifiable by overcurrent protective equipment. A series arc fault, on the other hand, adds series impedance to the circuit and hence reduces the load current. Overcurrent protection devices are unable to detect the series arc faults by monitoring signal quality of a given system, at least because of the addition of series impedance, which adversely affects the signal quality.

The National Electrical Code (NEC) 2020 section 690.11 states that a photovoltaic system operating at or more than 80 Volts (V) DC requires a photovoltaic arc fault circuit interrupter (AFCI). Underwriter Labs (UL) standard 1699B Edition 2018 (“Photovoltaic (PV) DC Arc-Fault Circuit Protection”) requires arc faults in photovoltaic systems to be extinguished by a photovoltaic AFCI circuit either before dissipating 750 Joules (J) of arc energy or before 2.5 seconds of arcing have elapsed since arc detection, whichever comes first.

Today's photovoltaic arc fault detection (AFD) apparatus and AFCI apparatus are adversely impacted due to many factors, including but not limited to antenna effect, crosstalk, inverter switching harmonics, inverter noise, condition of photovoltaic cells, the health of photovoltaic modules, and the topology of the photovoltaic system. In general, the presence of noise distorts the frequency spectrum and hampers the accuracy of detection methods that utilize, but are not limited to, discrete wavelet transform (DWT) (also known as wavelet transform) and Fast Fourier Transform (FFT) methodology. As implemented in some AFD and AFCI devices, the use of DWT and FFT methodology relies on hand-adjusted threshold values. These threshold values require adjustment depending on each specific operating condition. These issues may affect/mask/distort an arc signal and cause AFDs and AFCIs to malfunction and operate falsely.

Arc faults are dangerous. An electrical arc may damage the photovoltaic cells and/or its associated DC to AC inverter. An electrical arc may start a fire, may burn a user, or may otherwise destroy property. Engineers and scientist are continually searching for ways to quickly detect an electrical arc, referred to as an arc fault, and to quickly interrupt the circuit that is feeding current/voltage to the electrical arc.

### BRIEF SUMMARY OF SOME EXAMPLES

The systems, methods, and devices of this disclosure each have several innovative aspects, no single one of which is solely responsible for the desirable attributes disclosed herein.

In one example, an apparatus is described. The apparatus includes a first terminal and a second terminal distal from the first terminal. The apparatus includes a solid state circuit breaker having a third terminal coupled to the first terminal, and a fourth terminal coupled to the second terminal, the solid state circuit breaker selectively configured as a closed switch or an open switch. The apparatus includes a current sensor coupled to a current path coupling the first terminal and the second terminal and configured to sense an electrical current flowing on the current path while the solid state circuit breaker is configured as the closed switch. The apparatus also includes a student convolutional neural network (CNN) model that was pretrained using a knowledge distillation-based teacher-student approach, the student convolutional neural network (CNN) model coupled to the solid state circuit breaker and the current sensor and configured to process data representative of the electrical current, the data being processed cyclically with a period defined by an arc fault detection cycle. According to some aspects, in response to the student CNN model detecting, in association with the electrical current, an arc fault lasting a predetermined number of consecutive arc fault detection cycles, the solid state circuit breaker is reconfigured as the open switch.

In one example, an apparatus is described. The apparatus includes a first terminal and a second terminal distal from the first terminal. The apparatus includes a solid state circuit breaker having a third terminal coupled to the first terminal, a fourth terminal coupled to the second terminal, and a control input, the solid state circuit breaker being selectively configured as a closed switch or an open switch based on a first state of the control input or a second state of the control input, respectively. The apparatus includes a current sensor coupled to a current path coupling the first terminal and the second terminal and configured to sense an electrical current flowing on the current path. The apparatus also includes one or more processors coupled to the control input and the current sensor, and one or more memories coupled to the one or more processors, the one or more processors configured to execute instructions stored on the one or more memories that, when executed by the one or more processors, cause the one or more processors to: configure at least a portion of the one or more processors as a student convolutional neural network (CNN) model that was pretrained using a knowledge distillation-based teacher-student approach, set the first state at the control input to configure the solid state circuit breaker as the closed switch, process data representative of the electrical current utilizing the student CNN model, the data being processed cyclically with a period defined by an arc fault detection cycle, and set the second state at the control input to reconfigure the solid state circuit breaker as the open switch, in response to the student CNN model detecting, in association with the electrical current, an arc fault lasting a predetermined number of consecutive arc fault detection cycles.

In another example, a method is described. The method includes configuring at least a portion of one or more processors as a student convolutional neural network (CNN) model that was pretrained using a knowledge distillation-based teacher-student approach, configuring a solid state circuit breaker controlled by the student CNN model as a closed switch, processing data representative of an electrical current flowing through the closed switch of the solid state circuit breaker utilizing the student CNN model, the data being processed cyclically with a period defined by an arc fault detection cycle, and reconfiguring the solid state circuit breaker as an open switch in response to the student CNN model detecting, in association with the electrical current, an arc fault lasting a predetermined number of consecutive arc fault detection cycles.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a block diagram of a first configuration of a series combination of a string of DC power sources, an AFCI, and a DC to AC inverter according to some aspects of the disclosure.

FIG. 2 is a block diagram of a second configuration of a first series combination of a first string of DC power sources, a first AFCI apparatus, and a first DC to AC inverter in parallel with a second string of DC power sources, a second AFCI apparatus, and a second DC to AC inverter according to some aspects of the disclosure.

FIG. 3 is a schematic diagram of photovoltaic arc fault data collection test bench according to some aspects of the disclosure.

FIG. 4 is a graph of dataset structure samples projected into the frequency domain using t-Distributed Stochastic Neighbor Embedding (t-SNE) according to some aspects of the disclosure.

FIG. 5 is a schematic representation of a knowledge distillation framework of a teacher-student knowledge distillation model according to some aspects of the disclosure.

FIGS. 6A and 6B are schematic representations of architectures of a teacher convolutional neural network model and a student convolutional neural network model, respectively, both associated with a knowledge distillation framework according to some aspects of the disclosure.

FIG. 7 is a block diagram illustrating an example of a hardware implementation of an arc fault circuit interrupter apparatus included in a power delivery system, where the arc fault circuit interrupter apparatus employs one or more processing systems according to some aspects of the disclosure.

FIG. 8 is a graph depicting exemplary performance of an AFCI apparatus employing a 2-cycle arc fault detection approach according to some aspects of the disclosure.

FIG. 9 is a graph depicting exemplary performance of an AFCI apparatus employing a 1-cycle arc fault detection approach according to some aspects of the disclosure.

FIG. 10 is a graph depicting exemplary performance of an AFCI apparatus employing a 5-cycle arc fault detection approach according to some aspects of the disclosure.

FIG. 11 is a flow chart illustrating an example process at an AFCI apparatus in accordance with some aspects of the disclosure.

FIG. 12 is a flow chart illustrating an example process at an AFCI apparatus in accordance with some aspects of the disclosure.

Like reference numbers and designations in the various drawings indicate like elements.

### DETAILED DESCRIPTION

The detailed description set forth below in connection with the appended drawings is directed to some particular examples for the purpose of describing innovative aspects of this disclosure. It is intended as a description of various configurations and is not intended to represent the only configurations in which the concepts described herein may be practiced. A person having ordinary skill in the art will readily recognize that the teachings herein can be applied in a multitude of different ways. The examples described can be implemented in any device, system, or network that is capable of protecting power distribution networks of any size.

The detailed description includes specific details for the purpose of providing a thorough understanding of various concepts. However, it will be apparent to persons having ordinary skill in the art that these concepts may be practiced without these specific details. In some examples, well-known structures and components are shown in block diagram form in order to avoid obscuring such concepts.

While aspects and examples are described in this application by illustration to some examples, persons having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices. While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of apparatus, components, systems, end-user devices, etc. of varying sizes, shapes, and constitution.

The various concepts presented throughout this disclosure may be implemented across a broad variety of electrical systems, system architectures, and electrical and/or power distribution standards.

It is noted that while examples provided herein may be expressed in connection with photovoltaic systems, the scope of the disclosure is not limited to photovoltaic systems. Other systems, including but not limited to systems that utilize DC energy storage (e.g., DC batteries), are within the scope of the disclosure.

The growing adoption of photovoltaic (PV) systems for renewable energy generation addresses the urgent need to reduce carbon emissions and mitigate environmental impacts. These systems convert solar radiation into electricity, offering a clean and renewable energy source for distributed generation in households and other sunny locations. However, with widespread deployment, safety challenges emerge, particularly in detecting and mitigating series DC arc faults. These faults may be caused by loose connections, insulation failures, or aging components. They pose risks such as fires, equipment damage, and power interruptions. DC arc faults may reach temperatures exceeding 5000° C.

Unlike AC arcs, DC arcs lack natural zero-crossings, complicating detection under conditions like inverter startups, shadowing, and load changes. Conventional overcurrent protection devices fail to detect these faults due to reduced load current (series arcs increase impedance, thus lowering current). Traditional arc fault detection methods, including threshold-based analysis techniques are limited by high false-positive rates, sensitivity to operational noise, and difficulty distinguishing actual faults. Methods relying on physical signal characteristics, such as arc light or electromagnetic emissions, are similarly constrained by random arc occurrences, complicating localization.

In order to improve the accuracy of arc fault detection, artificial intelligence-based (AI-based) methods are described herein. As the feature generation is automatic within an AI-based model, machine learning-based and supervised learning-based models need not require hand-adjusted threshold values. AI-based models may exhibit high accuracy in detecting DC arc faults. However, their computational complexity hinders the AI-based methods from being implemented in commercial microcontroller units (MCUs). Commercial MCUs have small memory size and small sizes of random access memory (RAM).

To counteract these drawbacks, examples described herein may utilize certain AI-based fault detection processes that have high arc fault detection accuracy and are lightweight in size and computational power or capability. Here the words “lightweight in size and computational power or capability” (also simply referred to as “lightweight”) means such AI-based fault detection processes require less memory size and less RAM than traditional AI-based fault detection process (if any such processes exist). The aspects described herein may be sufficiently lightweight such that they may be implemented in an edge device and reliably and accurately operate in real time.

Industrial applications of AI-based models have strict limitations on model sizes due to multitasking, running time, and cost issues, for example. Reduction of model sizes offers the benefit of at least lowered computational burdens and therefore makes it possible to run the AI-based models described herein in connection with AFCI applications in resource-limited computing devices.

Aspects described herein may reduce the size of AI-based models by utilizing structural blocks of models that are different from those found in today's devices. Aspects described herein may utilize a lightweight process that can reliably detect series arc faults in DC systems, including but not limited to photovoltaic systems, with high accuracy and efficiency.

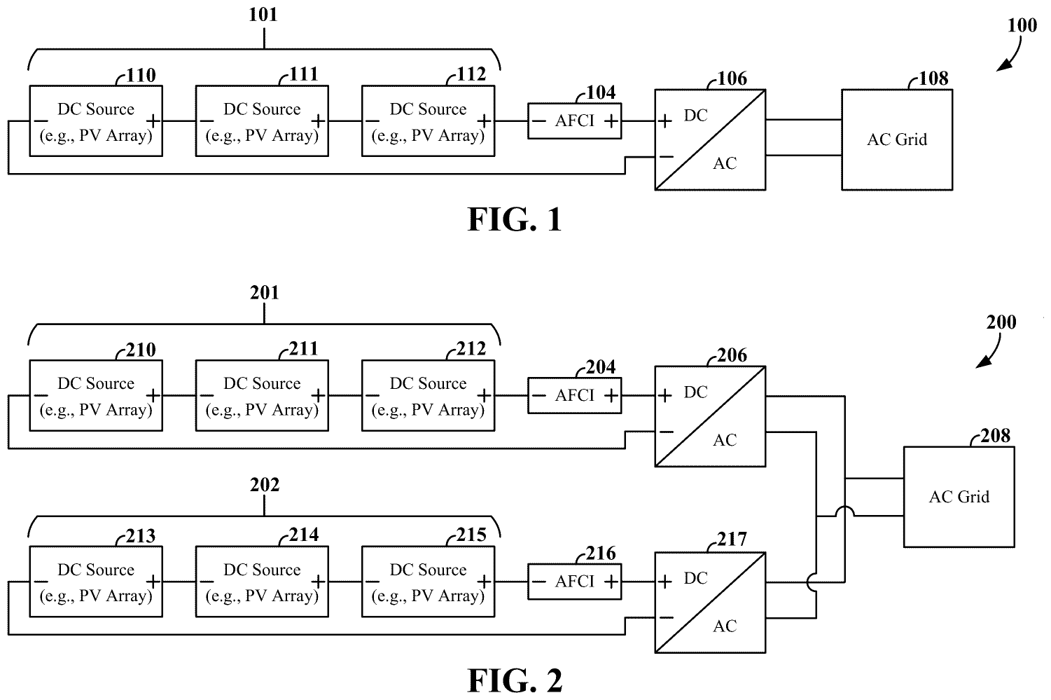

Physical examples of AFCI apparatus according to some aspects of the disclosure were constructed and tested to prove their concept. Instead of relying on model-based simulation tools such as MATLAB/Simulink, the examples of AFCI apparatus were tested using databases generated by a tangible test platform constructed in accordance with the UL standard 1699B Edition 2018, to gather a comprehensive photovoltaic arc fault database. The platform included a photovoltaic simulator, an arc fault generator, a commercial grid-tied inverter (i.e., a DC to AC inverter), and mains power from the public utility grid. Data collection encompassed varying current and voltage levels, with arc faults intentionally induced at different photovoltaic string locations (for an explanation of a photovoltaic string, see the text associated with FIGS. 1 and 2, below) to evaluate a robustness of the arc fault detection process exemplified herein and provided according to some aspects of the disclosure. The resulting extensive database, generated under diverse operating conditions, enhances the robustness of the AI-based models described herein.

Also described herein is a lightweight and computationally efficient Convolutional Neural Network (CNN) designed for detection of series DC arc faults, such as, but not limited to, series arc faults in photovoltaic systems and series arc faults of any sort of DC system and series arc faults of any battery systems. The CNN described herein provided an accuracy of 98.14%. Distinguishing itself from contemporaneous CNN block network architectures, the network architecture exemplified herein employs pointwise convolution and depthwise convolution layers, some of which operate on one half of the channels provided in the architecture while others operate on all of the channels provided in the architecture. Strategic convolution and Max-Pooling layers, coupled with a bottleneck structure, contribute to optimizing accuracy. The models described herein demonstrate proficiency in detecting series arc faults within photovoltaic systems but are not limited to photovoltaic systems. The models described herein may be applied to any DC system.

Aspects described herein may utilize a solid-state circuit breaker (SSCB), which may be based on a metal-oxide-semiconductor field-effect transistor (MOSFET) design to interrupt the circuit promptly during arc faults. The use of a SSCB provides at least the benefit of a reduction in operating speed of the AFCI apparatus described herein in comparison with an AFCI apparatus that does not utilize an SSCB and the benefit of improving an ability of the AFCI apparatus to effectively safeguard a system from potential fire hazards and/or equipment damage due to arc faults, by reducing the time between accurate detection of an arc fault and the interruption of the current in an AFCI protected system.

Aspects of the CNN-based, AI-based AFCI apparatus described herein may be optimized to reduce binary size and latency, facilitating their implementations in resource-limited edge devices. Aspects described herein were implemented using a commercial microcontroller unit (MCU), specifically a STM32H743ZI2, having a 32-bit Arm Cortex architecture with 2 MB of internal memory and 1 MB of internal RAM. The implemented aspects demonstrated real-time operational capabilities for commercial use, with an estimated inference time per sample of 9 ms on the STM32H743ZI2. The exemplary SSCB architecture achieved rapid operation, breaking the circuit in just 33 microseconds. The overall time to clear an arc fault was no more than 19 ms, which included data acquisition, preprocessing, model evaluation, and AFCI SSCB tripping time. In more detail, the 19 ms included 10 ms for input signal capture and 9 ms for data processing and AI-based inference.

FIG. 1 is a block diagram of a first configuration 100 of a series combination of a string 101 of DC power sources 110, 111, 112 (e.g., photovoltaic sources, solar panels, batteries), an arc fault circuit interrupter (AFCI) apparatus 104, and a DC to AC inverter 106 according to some aspects of the disclosure. As used herein, the terms “DC source” and “DC power source” may be used interchangeably. In the first configuration 100, the string 101 of DC power sources 110, 111, 112 are series coupled to each other. The string 101 is coupled in series with the AFCI apparatus 104, and the DC to AC inverter 106. The DC to AC inverter 106 is coupled to an AC grid 108 (or load).

FIG. 2 is a block diagram of a second configuration 200 of a first series combination of a first string 201 of DC power sources 210, 211, 212 (e.g., photovoltaic sources, solar panels, batteries), a first AFCI apparatus 204, and a first DC to AC inverter 206 in parallel with a second string 202 of DC power sources 213, 214, 215, a second AFCI apparatus 216, and a second DC to AC inverter 217 according to some aspects of the disclosure. In the second configuration 200, the first string 201 of DC power sources 210, 211, 212 are series coupled to each other. The first string 201 is series coupled to the first AFCI apparatus 204 and the first DC to AC inverter 206. The second string 202 of DC power sources 213, 214, 215 are series coupled to each other. The second string 202 is series coupled to the second AFCI apparatus 216 and the second DC to AC inverter 217. The first DC to AC inverter 206 and the second DC to AC inverter 217 are coupled in parallel with an AC grid 208 (or load).

Coupling a plurality of DC power sources in series (e.g., the string 101 of DC power sources 110, 111, 112; the first string 201 of DC power sources 210, 211, 212; the second string 202 of DC power sources 213, 214, 215) increases a total voltage of the string because voltages add in series. Using FIG. 1 as an example, the total voltage of the string 101 would equal the voltage of the first DC power source 110 plus the voltage of the second DC power source 111 plus the voltage of the third DC power source 112.

A series arc fault may occur anywhere in the first configuration 100 of FIG. 1 between any two DC power sources, between the AFCI apparatus 104 and the third DC power source 112, between the DC to AC inverter 109 and the AFCI apparatus 104, and/or between the DC to AC inverter 109 and the first DC power source 110. A series arc fault may also occur within an internal component or connection within any one or more of the just recited devices.

According to some aspects of the disclosure, the AFCI apparatus 104, which may be configured as a solid state circuit breaker (e.g., an electronically controllable or selectable switch, a single pole single throw switch) enabled by a student convolutional neural network (CNN) model that was pretrained using a knowledge distillation-based teacher-student approach (also referred to as a student CNN model herein) protects the string 101 of DC power sources 110, 111, 112 and the DC to AC inverter 106 from damage caused by a series arc fault. The protection may be obtained, for example, by continuous analysis of the DC current flowing through the series coupled devices and detection of at least a first arc fault. In response to detecting the at least first arc fault, one or more processors of the AFCI apparatus 104 may selectively open a solid state circuit breaker associated with the AFCI apparatus 104, thereby interrupting the current flowing through the series coupled devices and extinguishing the detected arc. According to some aspects, to improve reliability and accuracy in the detection of arc faults and the protection of components/circuits served by the AFCI apparatus 104, the opening of the solid state circuit breaker may occur after the AFCI apparatus 104 detects (e.g., determines an existence of, a presence of, evidence of) an arc fault lasting for a predetermined number of consecutive arc fault detection cycles. According to some aspects, the predetermined number may be in a range of 1 to 10, or more specifically in a range of 3 to 7. In one example, the predetermined number may be 5. The feature detecting an arc fault and waiting a predetermined number of consecutive arc fault detection cycles (after detecting the arc fault) before tripping (e.g., opening) a solid state circuit breaker to clear the arc fault may improve or enhance a reliability of an AFCI apparats, such as those shown and described herein, with respect to an AFCI that did not incorporate, for example, a student convolutional neural network (CNN) model that was pretrained using a knowledge distillation-based teacher-student approach. The improvement in reliability is realized in terms of an improvement of detection accuracy (compared to dissimilar AFCI apparatus) and a reduction in false trips (e.g., false detection, false or unnecessary openings) of circuit breakers. The described aspects, which may be referred to as a multi-cycle detection strategy (e.g., ongoing detection of an arc fault for 5-cycles before tripping a solid state circuit breaker), may enhance an operational stability of the AFCI apparatus 104 without compromising safety of the apparatus or users associated with the apparatus; where the enhancement may be made relative to not practicing the multi-cycle detection strategy.

A similar result may be obtained in each of the plurality of strings of DC power sources depicted in FIG. 2. In FIG. 2, coupling the plurality of strings of DC power sources (and each string's respective arc fault circuit interrupter apparatus and DC to AC inverter) in parallel increases the overall current of the second configuration 200 because current adds in parallel. Accordingly, the current of the parallel combination of the first string 201 (and its attendant first AFCI apparatus 204 and first DC to AC inverter 206) and the second string 202 (and its attendant second AFCI apparatus 216 and second DC to AC inverter 217) would equal the current supplied by the first string 201 plus the current supplied by the second string 202.

In the example of FIG. 2, the first AFCI apparatus 204 and the second AFCI apparatus 216 operate independently of each other. Accordingly, and by way of example and not limitation, in response to the second AFCI apparatus 216 detecting (e.g., determining an existence of, a presence of, evidence of) an arc fault lasting for a predetermined number of consecutive arc fault detection cycles, the second AFCI apparatus 216 may cause a solid state circuit breaker associated with the second AFCI apparatus 216 to trip (i.e., to open). Opening the solid state circuit breaker would “clear” the arc fault (e.g., extinguish it by stopping a current feeding the arc fault). For example, the arc fault might occur anywhere in the second string 202 of DC power sources 213, 214, 215. Tripping the solid state circuit breaker in the second AFCI apparatus 216 need not have any effect on the first AFCI apparatus 204. According to some aspects, the predetermined number may be in a range of 1 to 10, or more specifically in a range of 3 to 7. In one example, the predetermined number may be 5.

It is noted that aspects described herein may be implemented with any number of series coupled DC power sources in a string, where the number is 1 or greater than 1 (as shown in the example of FIG. 1, where the number is 3 for example). It is also noted that aspects described herein may be implemented with any number of two or more parallel strings of DC power sources as shown in FIG. 2 for example (where 2 parallel strings of DC power sources are exemplified). The use of three DC power sources in a string and two parallel strings of DC power sources is for illustrative and non-limiting purposes.

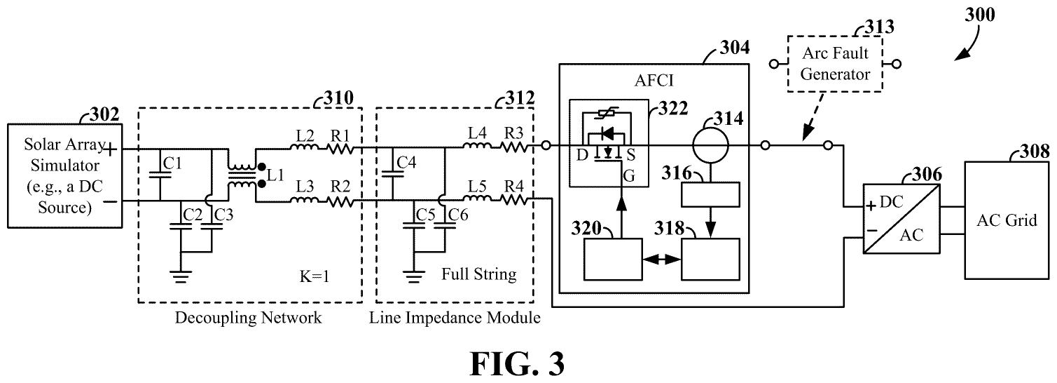

FIG. 3 is a schematic diagram of photovoltaic arc fault data collection test bench (referred to hereinafter as the test bench 300) according to some aspects of the disclosure. The photovoltaic arc fault data collection test bench 300 was designed according to, and is compliant with, the UL standard 1699B Edition 2018. The UL standard 1699B may be used to collect a comprehensive dataset of arc faults under diverse operating conditions. This dataset may be used to enhance model generalization and ensure reliable detection performance across real-world scenarios. Because the test bench 300 is compliant with UL standard 1699B, the dataset is also compliant with the UL standard. However, the DC source may be any source of DC power (e.g., photovoltaic energy cells, batteries, DC distribution systems, etc.). The DC voltage of the DC source is provided to a DC to AC inverter 306 (also referred to as a grid-tied inverter (GTI)), which converts the DC power to AC power. The AC power is then fed to and distributed by the AC grid 308. The DC to AC inverter 306 is coupled to mains power, represented schematically as an AC grid 308. An example of the AC grid 308 is a 208 V, two-phase, 60 Hz, AC power grid.

Aspects of the AFCI apparatus 304 described herein were tested utilizing the test bench 300 and the dataset obtained via use of the test bench 300. A comprehensive dataset was collected to ensure the robustness and reliability of the AFCI apparatus 304 under diverse operating conditions. The test bench 300 includes a DC source, which was a programmable solar array simulator 302. An example of the programmable solar array simulator 302 is Chroma 62180D-1800, rated at 18 kW, 1.8 kV, and 40 A.

Arc faults were generated at multiple points along the photovoltaic string (represented by the programmable solar array simulator 302) using an arc fault generator 313. The arc fault generator was equipped with a stepper motor (not shown) to separate electrodes (not shown) of the arc fault generator 313 at a constant or variable speed, typically 5 mm/s. Data collection included fixed and variable arc gap conditions, with current and voltage ranges of 3 to 8.5 A and 490 to 600 V, respectively as shown in Table I.

TABLE I
Test Conditions For Photovoltaic Arc Fault Data Collection

| | Impp | Min Iarc | Vmpp | | |
|---|---|---|---|---|---|
| SL No. | (A) | (A) | (V) | Isc (A) | Voc (V) |
| 1 | 3 | 2.5 | 400 | 4 | 490 |
| 2 | 4 | 3.5 | 480 | 5 | 550 |
| 3 | 5 | 4.5 | 500 | 6 | 600 |
| 4 | 6 | 5.5 | 520 | 7.5 | 600 |
| 5 | 7 | 6.5 | 520 | 8.5 | 600 |
| 6 | 8.5 | 8 | 540 | 10 | 600 |

The ranges of current and voltage provided in Table I are for purposes of example and discussion and not limitation. In many applications, currents may surpass 8.5 A (e.g., 25 A or above) and voltages may exceed 600V (e.g., 1200V or above). The scope of this disclosure encompasses all currents and voltages as may be encountered in association with the AFCI apparatus as shown and described herein.

Use of the programmable solar array simulator 302 facilitated inclusion of variations in loads, inverter startup, shadow occlusions, and sudden load changes in the database. Table I, above, summarizes the test conditions (maximum power point voltages (Vmpp) and currents (Impp), and arc current Iarc). Both the alternating current (AC) grid (represented as AC grid 308) and resistive loads (not shown) were utilized as loads for the DC to AC inverter 306 (i.e., a grid tied inverter).

In the example of FIG. 3, the DC source used in the collection of data for training the CNN model is the programmable solar array simulator 302 (also referred to as a photovoltaic array simulator or a PV simulator). The programmable solar array simulator 302 may simulate many parameters associated with a photovoltaic DC source. The parameters include, but are not limited to shadow occlusions, noise, and sudden load changes.

During data collection, the AFCI apparatus 304 was excluded from the test bench 300 and the arc fault generator 313 was added to the test bench 300 as graphically depicted in FIG. 3. The AFCI apparatus 304 was integrated into the test bench 300 during real-time testing. In greater detail, the AFCI apparatus 304 may include a current sensor 314. The current sensor 314 may be any type of current sensor known to persons having ordinary skill in the art. For example, the current sensor may be 314 may be a Hall Effect sensor, a shunt resistor, a Rogowski coil, a fluxgate sensor, and a current transducers, a current transformer. The preceding list is exemplary and not limiting. The current sensor 314 may provide its output to a signal processing apparatus 316. Depending on the current sensor 314 and other components of the AFCI apparatus 304, the signal processing apparatus 316 may include amplifier(s), analog to digital converter(s), Fast Fourier Transform (FFT) processor(s), other digital signal processing processor(s), etc. The preceding list is exemplary and not limiting. The AFCI apparatus 304 may also include a processing system 318. The processing system 318 may include one or more processors, one or more memories, one or more computer-readable memory devices, etc. The processing system 318 may be configured as a student CNN model according to some aspects. The AFCI apparatus 304 may include a switch driver 320, configured to drive a switch, such as a MOSFET implemented solid state circuit breaker 322 as illustrated in FIG. 3 for exemplary and non-limiting purposes.

Circuit components in the decoupling network 310 and the line impedance module 312 adhered to the UL standard 1699B standard. The component values are as follows: C1=20 μF, C2=C3=22 nF, C4=150 nF or 10 μF, C5=C6=1 nF, L1=12 mH, L2=L3=60 μH, L4=L5=50 μH, R1=R2=(10˜27) Ω, R3=R4=1Ω. This setup ensured compliance with the UL standard requirements and supported comprehensive data collection for arc fault detection. The alternative values of C4 were used to simulate a standard case scenario (e.g., normal conditions) of 150 nH and a worst case scenario of 10 μF. The apparatus described herein were tested separately utilizing the two respective values of C4.

A Tektronix mixed-signal oscilloscope (model no. MSO58) was used to record arc gap voltage and current data at 250 kS/s. For simplicity, the data was down sampled to 51.2 kS/s with a sample length of 10 ms before performing an FFT. The 10 ms cycle represents the time window during which the system may collect and process arc fault data. This value may be based on arc signal characteristics. The 10 ms cycle includes at least two components: data processing (e.g., FFT-based feature extraction, filtering, and normalization) and AI model inference (e.g., CNN-based arc fault detection such as that exemplified herein). While a system may process data in 10 ms intervals, the combined data processing and inference time adds an additional 7-9 ms per cycle, effectively extending the total arc fault detection cycle to approximately 19 ms. Consequently, for 5 cycles, the arc fault clearing time (i.e., the time between initial detection of the arc fault and the time the circuit is interrupted (e.g., by tripping a circuit breaker) may be around 95 ms (5×19 ms), with variations observed between about 95 to 106 ms due to shifts in the start of the first cycle or computational overhead, for example.

According to some aspects, a single cycle may be defined as 10 ms of input current data. The cycle duration of 10 ms may be an empirically established and widely accepted standard in some research. However, other research considers cycle durations ranging from 2 ms to 20 ms. Still, the 10 ms cycle may be used as it effectively captures arc fault characteristics while maintaining computational efficiency. Nevertheless, as described herein, a total arc fault detection cycle may be approximately 19 ms in duration.

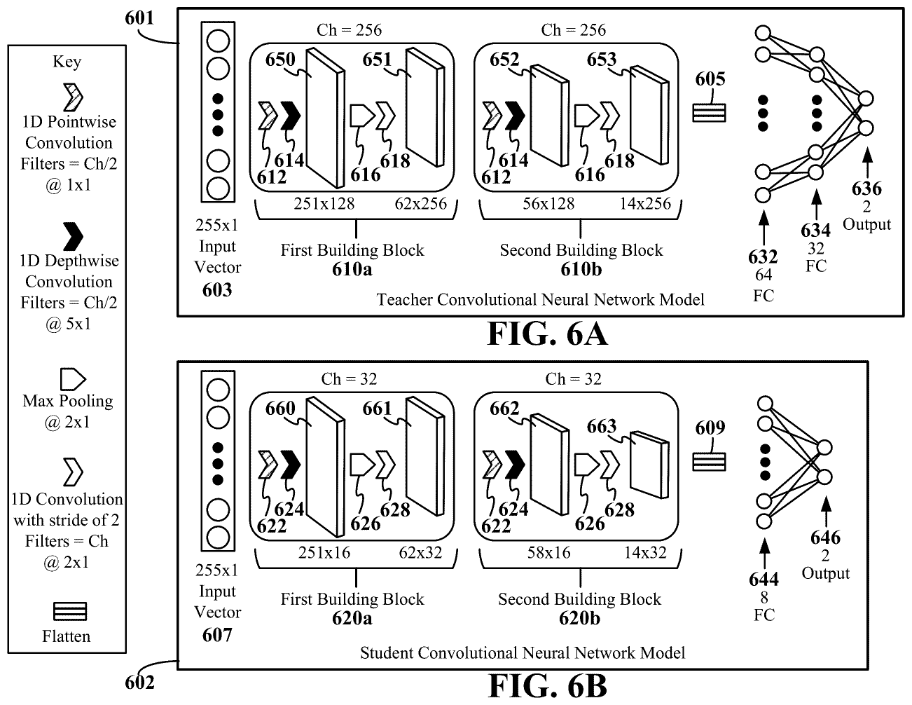

When the electrodes (not shown) of the arc fault generator 313 were in contact, under normal conditions, the arc generator voltage was zero. The arc gap voltage was within 13 to 50 V. The dataset consists of 102,000 normal samples and 52,000 arc samples as shown in Table II, below. The input to the model, i.e., the 255×1 input vector 603 of FIG. 6A and the 255×1 input vector 607 of FIG. 6B was the FFT data. However, nothing in the disclosure limits the input signals to be FFT data. All data samples were normalized using a Min-Max normalization technique.

TABLE II
Total Samples In the Dataset

| Arc Samples | Normal Samples | Total |
|---|---|---|
| 50,000 | 52,000 | 102,000 |

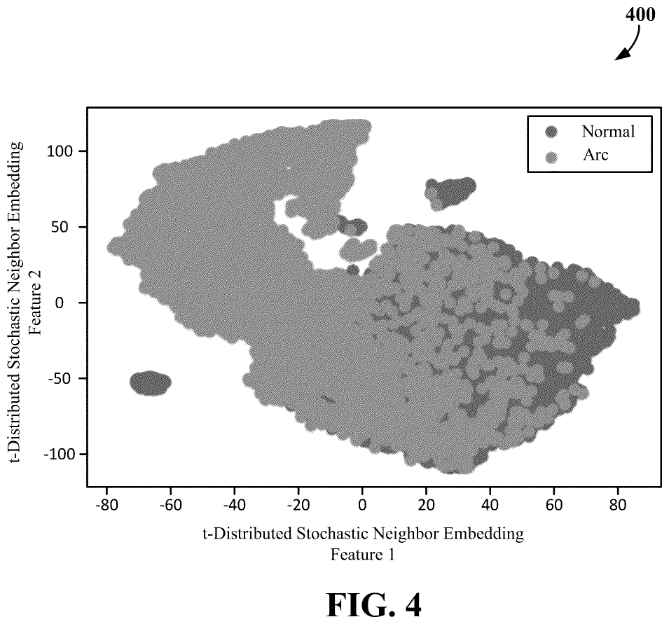

To evaluate the dataset structure, samples were projected into the frequency domain using t-Distributed Stochastic Neighbor Embedding (t-SNE). FIG. 4 is a graph 400 of the dataset structure samples projected into the frequency domain using the t-Distributed Stochastic Neighbor Embedding according to some aspects of the disclosure.

The results, shown in FIG. 4, highlight the complexity and scattered clustering of the data due to its diverse conditions. This variability emphasizes a need for advanced algorithms to classify arc faults accurately under real-world operating scenarios.

Features of the CNN model exemplified herein combine advanced convolutional techniques with knowledge distillation (KD) to achieve both high accuracy and a lightweight design. Knowledge distillation enables the transfer of knowledge from a larger, complex teacher CNN model to a smaller student CNN model, allowing the student to retain high performance while reducing computational demands. Initially, a teacher CNN model is trained to reach high accuracy by leveraging its computational power and memory capacity and capturing essential insights from the data. The student CNN model, which may have less computational power and memory capacity than the teacher CNN model, is then trained to replicate the teacher's outputs, benefiting from the teacher's learned patterns without needing the same extensive resources.

It is noted that apparatus within dashed boxes, including the decoupling network 310, the line impedance module 312, and the arc fault generator 313, are utilized to build a database of arc fault and normal indications in connection with the test bench 300. Under ordinary operating conditions the decoupling network 310, the line impedance module 312, and the arc fault generator 313 would not be present.

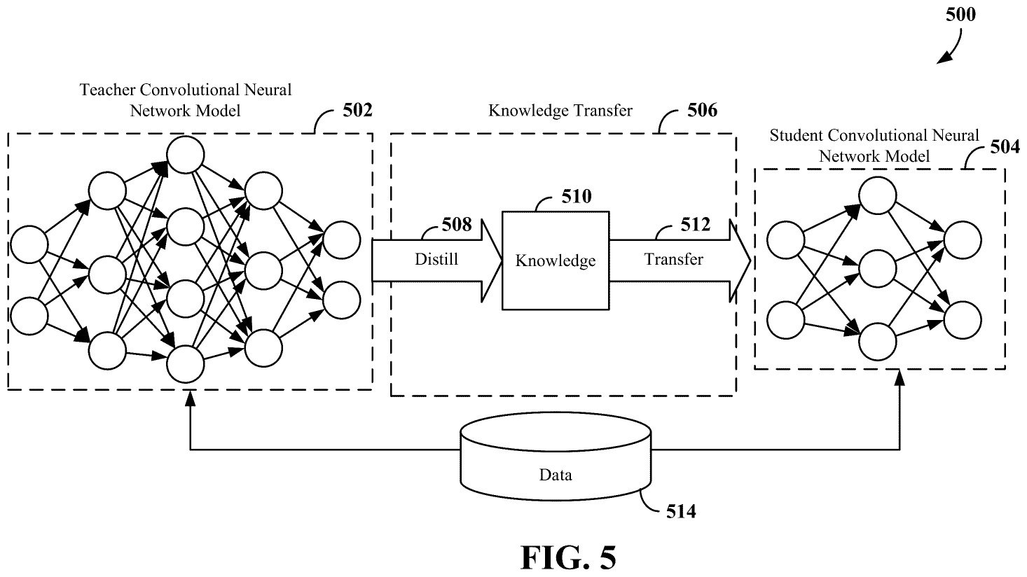

FIG. 5 is a schematic representation of a knowledge distillation framework 500 (that may be used with a teacher-student knowledge distillation model) according to some aspects of the disclosure. A teacher-student knowledge distillation technique may be employed to transfer knowledge obtained by a teacher convolutional neural network model 502 to a student convolutional neural network model 504. This technique allows the student model to learn from the softened probability distributions output by the teacher model, rather than solely relying on hard labels. As a result, the student model captures complex feature representations more efficiently while using significantly fewer parameters. The teacher-student knowledge distillation technique described herein enables model compression by training a smaller, computationally efficient student model that retains near-equivalent accuracy to the larger teacher model. Unlike direct parameter reduction techniques, knowledge distillation preserves critical decision boundaries by leveraging the richer information contained in the teacher's soft labels, making the convolutional neural network model exemplified herein lightweight and applicable to, for example, deployment in resource-constrained environments.

The one or more processors and processing system configuring the teacher convolutional neural network model 502 may have greater computational capability and grater storage capability in comparison to the one or more processors and processing system configuring the student convolutional neural network model 504. By relieving the student of some computational requirements, the demands made on the student are reduced. This reduction may contribute toward making the student convolutional neural network model 504 lightweight.

In the knowledge distillation technique, the teacher convolutional neural network model 502 (which is relatively large compared to the student convolutional neural network model 504) supervises the student convolutional neural network model 504 (which is relatively small compared to the teacher convolutional neural network model 502). The student convolutional neural network model 504 mimics the teacher convolutional neural network model 502 to achieve comparable or even superior performance than the teacher convolutional neural network model 502.

There are three main components in the knowledge distillation technique, namely knowledge 510, teacher-student architecture (i.e., the teacher convolutional neural network model 502 and the student convolutional neural network model 504), and knowledge transfer 506, which may include the distilled 508 knowledge 510 obtained by the teacher convolutional neural network model 502, and the transfer 512 of the knowledge 510 from a knowledge database (represented by the knowledge 510 block) to the student convolutional neural network model 504.

The respective teacher and student convolutional neural network models may use response-based knowledge. The overall system includes a strong teacher CNN model and a comparatively weaker student CNN model. The teacher CNN model is stronger so that it can gain as much information as possible from the data 514 available to both the teacher and student CNN models. The knowledge 510 is then distilled 508 from the teacher convolutional neural network model 502 to transfer 512 to the student convolutional neural network model 504 through a knowledge distillation process. The student CNN model 504 may be architecturally simplified relative to the teacher CNN model 502 to facilitate deployment in resource-constrained environments. However, the student CNN model 504 may retain a structural configuration comprising a number of convolutional neural network layers and fully connected (FC) layers that may be similar to or modified from the architecture of the teacher CNN model 502. According to such an example, the student CNN model may exhibit computational efficiency (compared to the teacher CNN model) while also maintaining inference accuracy (compared to the teacher CNN model).

A knowledge distillation framework may be constructed using at least two steps: producing softened probabilities for the teacher CNN model's output and using a distillation loss to align the student CNN model's output with that of the teacher CNN model. Performing the at least two steps ensure the student CNN model remains efficient and suitable for deployment on edge devices, which may have limited computational power and memory capacity in comparison to devices on which the teacher CNN model is deployed.

One example of producing softened probabilities for the teacher CNN model's output may be obtained using, for example, a SoftMax function. The SoftMax function may be used to convert a vector of K real numbers into a probability distribution of K possible outcomes. The SoftMax function may be a generalization of a logistic function to multiple dimensions. The SoftMax function may be used in multinomial logistic regression. The SoftMax function may be used as the last activation function of a neural network to normalize the output of the neural network to a probability distribution over predicted output classes. To use the SoftMax function, the teacher CNN model may generate a softened probability distribution using a temperature parameter, T, which smooths the logits. For a class i, the softened probability pi may be given as

$${p}_{i} = \frac{exp ( \frac{{z}_{i}}{T} )}{{\sum }_{j} exp ( \frac{{z}_{j}}{T} )} \qquad ( 1 )$$

where zᵢ is the logit for class i, representing the unnormalized output for that class, Tis the temperature parameter, with T>1 to produce a softened probability distribution, and pᵢ is the softened probability for class i.

A distillation loss in machine learning, particularly in the context of “knowledge distillation,” may refer to a loss function that measures a difference between output probabilities (often called “soft targets”) of a larger, more complex “teacher” model and a smaller, less complex “student” model. The distillation loss may measure how well the student CNN model is learning to mimic the teacher's predictions. Minimizing the distillation loss implies that the student CNN model is effectively inheriting knowledge from the teacher CNN model. To determine distillation loss, the student CNN model's output distribution is softened using the same temperature, T, as used by the teacher CNN model. The distillation loss, based on the Kullback-Leibler (KL) divergence between teacher and student outputs, is given as:

$${L}_{KD} = KL ( {p}^{teacher} ‖ {p}^{student} ) \qquad ( 2 )$$

where L_{KD} is distillation loss, p^{teacher} and p^{student} are softened output probabilities of the teacher and student CNN models, respectively.

The student CNN model minimizes a combined loss function, balancing the traditional supervised loss L_{CE} (cross-entropy between true labels and student predictions) with the distillation loss L_{KD}, to produce a total loss given by:

$${L}_{total} = α {L}_{CE} + ( 1 - α ) {T}^{2} {L}_{KD} \qquad ( 3 )$$

where, Lₜₒₜₐₗ is the total loss minimized during training, L_{CE} is the cross-entropy loss between true labels and student predictions, α is a weighting factor balancing the supervised and distillation loss components, T² is a scaling factor for L_{KD} based on the temperature. Typically, T is set greater than 1 to convey additional information through softened probabilities, and α controls the emphasis on true label supervision versus distillation.

FIGS. 6A and 6B are schematic representations of architectures of a teacher convolutional neural network (CNN) model 601 and a student CNN model 602, respectively, both associated with a knowledge distillation framework according to some aspects of the disclosure. The knowledge distillation framework may be the same as or similar to the knowledge distillation framework 500 as shown and described in connection with FIG. 5. To achieve high accuracy while maintaining computational efficiency, aspects described herein may leverage the pointwise and depthwise convolutions rather than traditional CNN blocks.

According to some aspects, pointwise convolutions may be exemplified as a 1×1 convolutions applied to each data point (pixel), reducing parameters and computations by constraining filter size. This effectively extracts features without increasing model size. One example of constraining filter size may be to apply a 1D pointwise convolution to one half of the channels (i.e., Ch/2) of a given building block. A first 1D pointwise convolution 612 (e.g., represented by the first chevron) with a filter size of 1×1, where the number of filters is equal to one half of the number of channels, is depicted in FIG. 6A. A second 1D pointwise convolution 622 (e.g., represented by the first chevron) with a filter size of 1×1, where the number of filters is equal to one half of the number of channels, is depicted in FIG. 6B.

According to some aspects, depthwise convolutions may be exemplified as a single filter applied to each input channel independently, significantly reducing the computational load compared to standard convolutional layers. Again, this effectively extracts features without increasing model size. One example of constraining filter size may be to apply a 1D depthwise convolution to one half of the channels (i.e., Ch/2) of a given building block. A first 1D depthwise convolution 614 with filter size=Ch/2 @ 5×1 may be denoted by the second chevron in FIG. 6A. A second 1D depthwise convolution 624 with filter size=Ch/2 @ 5×1 may be denoted by the second chevron in FIG. 6B.

Combining pointwise convolutions with depthwise convolutions may allow aspects described herein to maintain a high detection accuracy (i.e., high detection of arc faults) while remaining efficient enough for edge device deployment.

Use of pointwise and depthwise convolution layers may reduce computational burden compared to use of a traditional CNN layer. This technique may be utilized for both the teacher and student network in their network architecture designs.

Examples of the network architecture of the teacher and student CNN models are illustrated in FIGS. 6A and 6B, respectively. The teacher CNN model 601 starts with an input vector 603 of dimensions 255×1, which represents the extracted features from the arc fault data. In a first building block 610a, to capture complex patterns, the teacher CNN model 601 utilizes a 1D pointwise convolution 612 (the first chevron) with a filter size of 1×1 followed by a 1D depthwise convolution with a filter size of 5×1. These layers operate with channels (Ch) set to one-half, allowing the model to learn spatial relationships within the data efficiently (i.e., the learning is limited to one half of the channels (Ch/2) rather than all of the channels, which reduces the learning time by one-half). Following the 1D pointwise convolution 612 and the 1D depthwise convolution 614, the data 650 appears as a 251×128 matrix.

Thereafter, max pooling 616 with a 2×1 kernel further reduces the feature map size, ensuring compact representation before passing to fully connected layers. After the max pooling 616, a 1 D convolution 618 with a stride of 2 and a filter size of 2×1 for all the channels (not only one half of the channels) is applied for down-sampling, which reduces the data dimensions while retaining important features. At this point, the data 651 dimensions appear as a 62×256 matrix. Accordingly, the channels increase to a maximum of 256 in the final convolutional layer, enhancing the capacity of the teacher CNN model 601 to capture detailed features.

The process may be repeated at a second building block 610b. The second building block 610b receives the data 651 from the first building block 610a. In the second building block 610b, to capture complex patterns, the teacher CNN model 601 utilizes a 1D pointwise convolution 612 (the first chevron) with a filter size of 1×1 followed by a 1D depthwise convolution with a filter size of 5×1. These layers operate with channels (Ch) set to one-half, allowing the model to learn spatial relationships within the data efficiently (i.e., the learning is limited to one half of the channels (Ch/2) rather than all of the channels, which reduces the learning time by one-half). Following the 1D pointwise convolution and the 1D depthwise convolution, the data 652 appears as a 56×128 matrix.

Thereafter, max pooling 616 with a 2×1 kernel further reduces the feature map size, ensuring compact representation before passing to fully connected layers. After the max pooling 616, a 1 D convolution 618 with a stride of 2 and a filter size of 2×1 for all the channels (not only one half of the channels) is applied for down-sampling, which reduces the data dimensions while retaining important features. At this point, the data 653 dimensions appear as a 14×256 matrix. Accordingly, the channels increased to a maximum of 256 in the final convolutional layer, enhancing the capacity of the teacher CNN model 601 to capture detailed features.

After the convolutional layers, the feature maps are flattened 605 and passed through fully connected (FC) layers, reducing from 64 FC nodes 632, to 32 FC nodes 634, before reaching the 2 output nodes 636 of the output layer.

Turning to FIG. 6B, the student CNN model 602 shares a similar structure as the teacher CNN model 601 but with a reduced complexity. The reduced complexity may enable real-time deployment on edge devices. The student CNN model 602 also starts with a 255×1 input vector 607. In a first building block 620a, to capture complex patterns, the student CNN model 602 utilizes a 1D pointwise convolution 622 (the first chevron) with a filter size of 1×1 followed by a 1D depthwise convolution 624 with a filter size of 5×1. These layers operate with channels (Ch) set to one-half, allowing the model to learn spatial relationships within the data efficiently (i.e., the learning is limited to one half of the channels (Ch/2) rather than all of the channels, which reduces the learning time by one-half). Following the 1D pointwise convolution 622 and the 1D depthwise convolution 624, the data 660 appears as a 251×16 matrix.

Thereafter, max pooling 626 with a 2×1 kernel further reduces the feature map size, ensuring compact representation before passing to fully connected layers. After the max pooling 626, a 1 D convolution 628 with a stride of 2 and a filter size of 2×1 for all the channels (not only one half of the channels) is applied for down-sampling, which reduces the data dimensions while retaining important features. At this point, the data 661 dimensions appear as a 62×32 matrix. Accordingly, the channels increase to a maximum of 32 in the final convolutional layer, enhancing the capacity of the student CNN model 602 to capture detailed features.

After the convolutional layers, the feature maps are flattened 609 and passed through fully connected (FC) layers, reducing from 8 FC nodes 644, to 2 output nodes 646 of the output layer.

The process may be repeated at a second building block 620b. The second building block 620b receives the data 661 from the first building block 620a. In the second building block 620b, to capture complex patterns, the student CNN model 602 utilizes a 1D pointwise convolution 612 (the first chevron) with a filter size of 1×1 followed by a 1D depthwise convolution with a filter size of 5×1. These layers operate with channels (Ch) set to one-half, allowing the model to learn spatial relationships within the data efficiently (i.e., the learning is limited to one half of the channels (Ch/2) rather than all of the channels, which reduces the learning time by one-half). Following the 1D pointwise convolution and the 1D depthwise convolution, the data 662 appears as a 58×16 matrix.

Thereafter, max pooling 626 with a 2×1 kernel further reduces the feature map size, ensuring compact representation before passing to fully connected layers. After the max pooling 626, a 1 D convolution 628 with a stride of 2 and a filter size of 2×1 for all the channels (not only one half of the channels) is applied for down-sampling, which reduces the data dimensions while retaining important features. At this point, the data 663 dimensions appear as a 14×232 matrix. Accordingly, the channels increase to a maximum of 32 in the final convolutional layer, enhancing the capacity of the student CNN model 602 to capture detailed features.

The fully connected (FC) layer of the student CNN model 602 has 8 fully connected nodes 644, significantly fewer than the teacher CNN model 601, contributing to the reduced computational load. The final output layer of the student CNN model 602 has 2 output nodes 646, completing the arc fault detection process with fewer resources than the teacher CNN model 601.

Turning now to the training process, aspects of the training process described herein incorporate key parameters and techniques to ensure effective performance and minimize overfitting. The teacher CNN model comprises 430.88 k parameters, while the student CNN model is significantly lighter, with only 4.27 k parameters, thanks to the knowledge distillation process (described above) that enables the student CNN model to inherit knowledge from the larger teacher CNN model.

During training, the teacher CNN model used a batch size of 200 for 40 epochs, with early stopping activated at 39 epochs. The student CNN model, trained for 50 epochs with a batch size of 32, also employed early stopping at 35 epochs to avoid overfitting. Both models started with an adaptive learning rate of 0.001, and the student CNN model incorporated L1 regularization and a dropout layer (rate=0.5) in the final convolutional layer to further reduce overfitting.

Knowledge distillation was tuned with a temperature, T, of 5 and an alpha value of 0.3, balancing the influence of teacher predictions and ground truth data. The resulting training and validation accuracy for the student CNN model closely aligned, demonstrating strong generalization and effective overfitting control. The student CNN model achieved a stable training accuracy with validation accuracy following a similar trend, indicating the student CNN model is not overfitted.

As shown in Table III, the teacher CNN model, with its 430.88 k parameters, achieved the highest accuracy of 97.45%. This model, however, is significantly larger, with a model size of 5,135 kB, making it impractical for deployment on resource-constrained edge devices. The student CNN model, derived through knowledge distillation, has only 4.27 k parameters and a much smaller model size of 52 kB. Despite this reduction in size, the student CNN model achieved an accuracy of 96.52%, demonstrating that it retained most of the performance benefits of the teacher CNN model while being significantly more efficient.

TABLE III
Comparison of Teacher and Student CNN Models

| Model | Teacher | Student |
|---|---|---|
| Parameters | 430.88K | 4.27K |
| Accuracy | 97.45% | 96.52% |
| Loss | 0.0806 | 0.0385 |
| Model Size (kB) | 5,135 | 52 |

The confusion matrix shown in Table IV provides a detailed breakdown of the student CNN model's performance in classifying normal and arc fault conditions. Given that, the teacher CNN model correctly identified 10,207 out of 10,367 normal samples (98.46%) and 9,673 out of 10,033 arc samples (96.41%). It misclassified 160 normal samples as arcs (1.54%) and 360 arc samples as normal (3.59%). The student CNN model showed a slightly lower performance but still comparable, correctly classifying 10,167 out of 10,367 normal samples (98.07%) and 9,524 out of 10,033 arc samples (94.93%). The misclassification rates were 1.93% for normal samples and 5.07% for arc samples. This performance is close to that of the teacher CNN model, underscoring the effectiveness of the knowledge distillation process in maintaining high accuracy with a significantly smaller model.

TABLE IV
Confusion Matrix of Student CNN Model.

| | | Predicted | | |
|---|---|---|---|---|
| | | Normal | Arc | Total |
| Actual | Normal | 10167 (98.07%) | 200 (1.93%) | 1036.7 |
| | Arc | 509 (5.07%) | 9524 (94.93%) | 10033 |

| | |
|---|---|
| Total | 10400 |

| | |
|---|---|
| Type I Error (False Positive) | 1.93% |
| Type II Error (False Negative) | 5.07% |
| Overall Accuracy | 96.52% |

Accordingly, the teacher CNN model, while highly accurate, is too large for practical use in edge devices. The student CNN model, created through knowledge distillation, provides an efficient and almost equally accurate alternative to the teacher CNN model, making the student CNN model suitable for real-world applications.

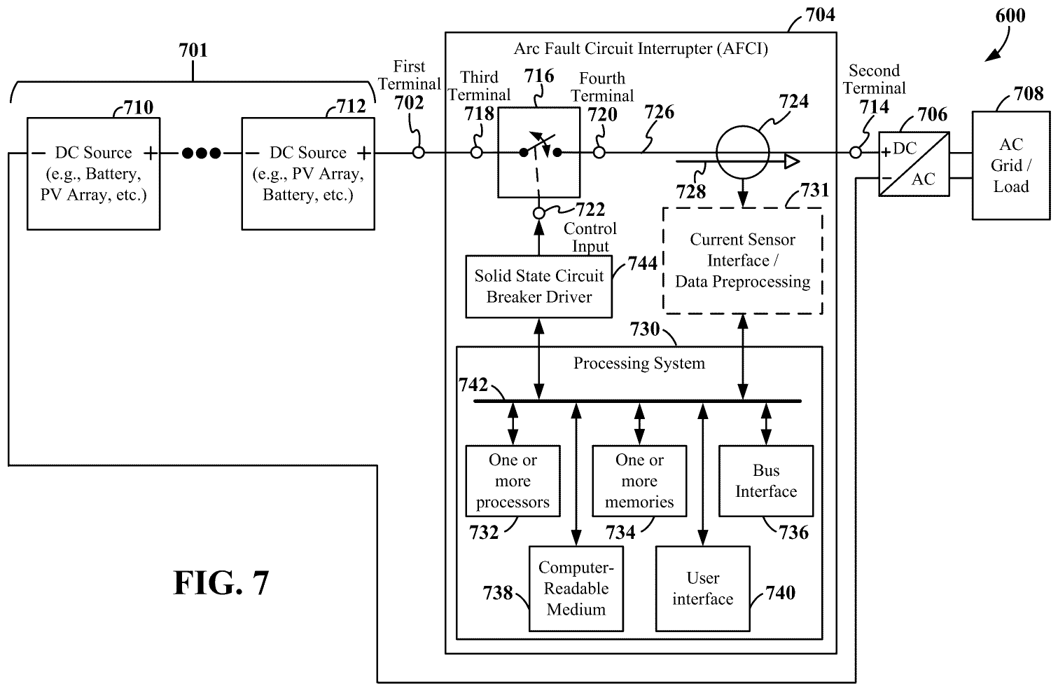

FIG. 7 is a block diagram illustrating an example of a hardware implementation of an arc fault circuit interrupter (AFCI) apparatus 704 included in a power delivery system 700, where the AFCI apparatus 704 employs one or more processing systems (generally represented by processing system 730) according to some aspects of the disclosure. The AFCI apparatus 704 may be similar to, for example, any of the AFCI apparatus 104, 204, 216, 304 or portions thereof depicted in FIGS. 1, 2, and/or 3.

The power delivery system 700 includes a string 701 of DC power sources (e.g., photovoltaic energy cells, batteries, etc.). The string 701 of DC power sources includes at least a first DC power source 710 and a second DC power source 712. However, nothing described herein limits the scope of this disclosure to use with a string of, or a plurality of, DC power sources. Accordingly, the power delivery system 700 incorporating at least one DC power source is within the scope of this disclosure.

Also included in the power delivery system 700 of FIG. 7 is a DC to AC inverter 706, similar to the DC to AC inverter 106 as shown and described in connection with FIG. 1, the first the DC to AC inverter 206 and the second DC to AC inverter 217 both as shown and described in connection with FIG. 2, and the DC to AC inverter 306 as shown and described in connection with FIG. 3. The descriptions of these devices are similar and will not be repeated for the sake of brevity.

The DC to AC inverter 706 is coupled to an AC grid 708, similar to the AC grid 108 as shown and described in connection with FIG. 1, the AC grid 208 as shown and described in connection with FIG. 2, and the AC grid 308 as shown and described in connection with FIG. 3. The descriptions of these devices are similar and will not be repeated for the sake of brevity.

Coupled between the DC to AC inverter 706 and the string 701 of DC power sources is an AFCI apparatus 704. According to one aspect, the AFCI apparatus 704 includes a first terminal 702 and a second terminal 714 distal from the first terminal 702. The AFCI apparatus 704 also includes a solid state circuit breaker 716 having a third terminal 718 coupled to the first terminal 702, and a fourth terminal 720 coupled to the second terminal 714, the solid state circuit breaker 716 selectively configured as a closed switch or an open switch. The AFCI apparatus also includes a current sensor 724 coupled to a current path 726 coupling the first terminal 702 and the second terminal 714 and configured to sense an electrical current 728 flowing on the current path 726 while the solid state circuit breaker 716 is configured as the closed switch. The AFCI apparatus 704 also includes a student convolutional neural network (CNN) model that was pretrained using a knowledge distillation-based teacher-student approach, the student convolutional neural network (CNN) model (which may reside in the one or more processors 732 of the processing system 730 and may operate in conjunction with the one or more memories 734 and/or the computer-readable medium 738 of the processing system 730) may be coupled to the solid state circuit breaker 716 and the current sensor 724. The coupling of the solid state circuit breaker 716 to the student CNN model may be via a solid state circuit breaker driver 744, for example. The coupling of the current sensor 724 to the student CNN model may be via a current sensor interface/data preprocessing circuit/apparatus 731, for example. The student CNN model may be configured to process data representative of the electrical current 728, the data being processed cyclically with a period defined by an arc fault detection cycle. According to some aspects, in response to the student CNN model detecting, in association with the electrical current 728, an arc fault lasting a predetermined number of consecutive arc fault detection cycles, the solid state circuit breaker 716 is reconfigured as the open switch.

According to some examples, after the solid state circuit breaker is reconfigured as the open switch, the solid state circuit breaker is maintained as the open switch until a user authorizes reconfiguring the solid state circuit breaker as the closed switch.

According to some examples, the student CNN model may be implemented as a plurality of building blocks. The respective building blocks of the plurality of building blocks may be implemented as: a one-dimensional pointwise convolution with one-half of all filters at a first sub-layer, wherein each of the one-half of all filters at the first sub-layer is a 1×1 matrix; a one-dimensional depthwise convolution with one-half of all filters at a second sub-layer, wherein each of the one-half of all filters at the second sub-layer is 5×1 matrix; a max pooling at a third sub-layer with a filter size of 2×1; and a one-dimensional convolution with a stride of two with all filters at a fourth sub-layer, wherein each of the all filters at the fourth sub-layer is a 2×1 matrix.

According to another aspect, or in other words, the AFCI apparatus 704 includes a first terminal 702 and a second terminal 714, distal from the first terminal 702. The AFCI apparatus 704 includes a solid state circuit breaker 716. The solid state circuit breaker 716 may be configured as, for example, an electronically controllable single pole single throw (SPST) switch, a MOSFET switch, a normally open switch, or a resettable switch which, after cycling from a closed state to an open state can only be reset to the closed state with a user authorization. The preceding list is exemplary and not limiting. The solid state circuit breaker 716 may have a third terminal 718 coupled to the first terminal 702, a fourth terminal 720 coupled to the second terminal 714, and a control input 722 (e.g., to receive control signals or bias signals to configure the solid state circuit breaker 716). In one example, the solid state circuit breaker 716 may be selectively configured as a closed switch or an open switch based on a first state of the control input or a second state of the control input 722.

The AFCI apparatus 704 may include a current sensor 724, similar to the current sensor 314 as shown and described in connection with FIG. 3. The description of the current sensor 724 will not be repeated for the sake of brevity. The output of the current sensor 724 may be coupled to a processing system 730. In some examples, the output of the current sensor 724 may be coupled to the processing system 730 via a current sensor interface/data preprocessing circuit/apparatus 731. In some examples, the output of the current sensor 724 may be coupled to the processing system 730 without a need of the current sensor interface/data preprocessing circuit/apparatus 731. In such an example, the processing system 730 may have, for example, a native analog input port, analog signal amplifier, and an analog to digital converter (not shown) and may perform data preprocessing without a need for external circuits to act as an interface or signal conditioner between the current sensor 724 and the processing system 730.

The AFCI apparatus 704 may include a current path 726 coupling the first terminal 702 and the second terminal 714. The current sensor 724 may be configured to sense an electrical current 728 flowing on the current path 726 or flowing between the third terminal and the fourth terminal when the solid state circuit breaker is configured as a closed switch.

As indicated, the AFCI apparatus 704 may include the processing system 730. In accordance with various aspects of the disclosure, an element, any portion of an element, or any combination of elements may be implemented with the processing system 730, which includes one or more processors 732, and one or more memories 734. Examples of a processor of the one or more processors 732 include microprocessors, microcontrollers, microcontroller units (MCUs), digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the AFCI apparatus 704 may be configured to perform any one or more of the functions described herein. That is, the one or more processors 732, as utilized in the AFCI apparatus 704, may be configured to, individually or collectively, based at least in part on information stored in the one or more memories 734 (or additionally or alternatively stored in whole or in part on the computer-readable medium 738), implement (e.g., perform) any one or more of the methods or processes described and illustrated, for example, in FIGS. 1, 2, 3, 5, 6A, 6B, 7, 11, and/or 12.

In this example, the processing system 730 may be implemented with a bus architecture, represented generally by the bus 742. The bus 742 may include any number of interconnecting buses and bridges depending on the specific application of the processing system 730 and the overall design constraints. The bus 742 communicatively couples together various circuits, including the one or more processors 732, the one or more memories 734, and one or more computer-readable media (generally represented by the computer-readable medium 738). The bus 742 may also link various other circuits such as timing sources, peripherals, voltage regulators, and power management circuits, which are well known to persons having ordinary skill in the art and, therefore, will not be described any further.

A bus interface 736 may provide an interface between the bus 742 and, for example and if needed, the current sensor 724, one or more analog-to-digital converters (not shown), one or more data current sensor interface/data preprocessing devices/circuits/functions (generally represented by the current sensor interface/data preprocessing circuit/apparatus 731), one or more solid state circuit breaker driver circuits (generally represented by a solid state circuit breaker driver circuit 744), and/or one or more solid state circuit breakers (generally represented by a solid state circuit breaker 716). The bus interface 736 may provide an interface between the bus 742 and a user interface 740 (e.g., a keypad, display, touch screen, speaker, microphone, control features, Bluetooth®/WiFi® interface, vibration circuit/device, etc.). Of course, such a user interface 740 is optional and may be omitted in some examples.

According to some aspects, the current sensor 724 coupled to the one or more processors 732, may be configured to derive a voltage waveform representative of the electrical current 728 flowing through the current path 726 in a time domain. According to some aspects, once the voltage waveform is converted from an analog to a digital signal, the one or more processors 732 may be configured to sample the digitized voltage waveform at a predetermined sampling rate to produce an input vector, such as the 255×1 input vector 607 as shown and described in connection with the student CNN model 602 of FIG. 6B.

The one or more processors 732 may be responsible for managing the bus 742 and general processing, including the execution of software stored (e.g., residing) on the one or more memories 734 and/or the computer-readable medium 738. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the one or more processors 732, causes the one or more processors 732 to perform the various processes and functions described herein for any particular apparatus.

The computer-readable medium 738 be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), flash memory on a processor of the one or more processors 732, a random access memory (RAM), Ram on a processor of the one or more processors 732, a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 738 may reside in the processing system 730, external to the processing system 730, or distributed across multiple entities, including the processing system 730. The computer-readable medium 738 may be embodied in a computer program product or article of manufacture. For example, a computer program product or article of manufacture may include a computer-readable medium in packaging materials. In some examples, the computer-readable medium 738 may be part of the one or more memories 734. Persons having ordinary skill in the art will recognize how best to implement the described functionality presented throughout this disclosure depending on the particular application and the overall design constraints imposed on the overall system. The computer-readable medium 738 and/or the one or more memories 734 may also be used for storing data that is manipulated by the one or more processors 732 when executing software.

In some aspects of the disclosure, the one or more processors 732 may include communication and processing circuitry (not shown) configured for various functions, including, for example, communication with other apparatus and performing processing processes. In some examples, the communication and processing circuitry may include one or more hardware components that provide the physical structure that performs processes related to wireless communication (e.g., signal reception and/or signal transmission) and signal processing (e.g., processing a received signal and/or processing a signal for transmission). The communication and processing circuitry may further be configured to execute communication and processing instructions (not shown) (e.g., software) stored, for example, on the computer-readable medium 738 to implement one or more functions described herein.

In some aspects of the disclosure, the one or more processors 732 may include circuitry (not shown) configured for various functions, including, for example, causing the one or more processors 732 to configure at least a portion of the one or more processors 732 as a student convolutional neural network (CNN) model that was pretrained using a knowledge distillation-based teacher-student approach. The circuitry may be configured to set the first state at the control input 722, to configure the solid state circuit breaker 716 as the closed switch. As used herein, the terms “set the first state” and “set the second state” may be references to setting a voltage at a predetermined level (e.g., a first state, a second state) or setting a logical status to a predetermined value (e.g., true or false, 1 or 0, etc.). The circuitry may be configured to process data representative of the electrical current 728 utilizing the student CNN model (such as the student CNN model 602 as shown and described in connection with FIG. 6B). According to some aspects, the data may be processed cyclically with a period defined by an arc fault detection cycle.

The one or more processors 732 may also include circuitry configured to set the second state at the control input 722 to reconfigure the solid state circuit breaker 716 as the open switch in response to the student CNN model detecting, in association with the electrical current, an arc fault lasting (e.g., continuously) a predetermined number of consecutive arc fault detection cycles.

According to some aspects, the solid state circuit breaker 716 may be a metal-oxide-semiconductor field-effect transistor (MOSFET) configured as a single pole single throw switch. In some examples, in an unbiased state, the solid state circuit breaker 716 presents a high impedance between the third terminal 718 and the fourth terminal 720, providing a failsafe open-switch-state at the solid state circuit breaker 716. In other words, in an absence of bias or a control signal, the solid state circuit breaker 716 may be configured as a high impedance, providing a failsafe open configuration at the solid state circuit breaker 716.

According to some aspects, the predetermined number is configurable. According to some aspects, a reliability of arc fault detections increases as the predetermined number increases. According to some aspects, the predetermined number is a number between 2 and 10, inclusive, or more specifically between 4 and 7, inclusive. The lower limit of each range provides improved reliability relative to having the predetermined number set equal to 1. However, setting the predetermined number to 1 is within the scope of this disclosure. In general, each predetermined number corresponds to an arc fault detection cycle. A maximum value for the predetermined number could be that value which when multiplied by a duration of one arc fault detection cycle yields a product that is less than 2.5 seconds. Where 2.5 seconds corresponds to a requirement set forth in Underwriter Labs (UL) standard 1699B Edition 2018.However, because it is desirable to reliably detect and extinguish (e.g., stop) an arc fault quickly, and with little to no false positives, the upper limit of the predetermined number may be less than 10. Given an exemplary arc fault detection cycle of about 19 ms, configuring the predetermined number to equal 5, for example, could correspond to a fault clearing time of about 95 ms (far less than the maximum value of 2.5 seconds set forth in the UL 1699B standard document).

According to some aspects, after setting the second state at the control input 722 to reconfigure the solid state circuit breaker 716 as the open switch, the one or more processors 732 may be further configured to maintain the reconfiguration of the solid state circuit breaker 716 as the open switch until receipt of a user authorization to again configure the solid state circuit breaker 716 as the closed switch.

In some aspects of the disclosure, the one or more processors 732 may include student CNN model circuitry configured for various functions, including, for example, implementing the student CNN model as a plurality of building blocks, each building block of the plurality of building blocks may be implemented in the order described next. Each building block may be configured as a one-dimensional pointwise convolution with one-half of all filters at a first sub-layer, where each of the one-half of all filters at the first sub-layer is a 1×1 matrix, followed by a one-dimensional depthwise convolution with one-half of all filters at a second sub-layer, where each of the one-half of all filters at the first sub-layer is a 5×1 matrix, followed by a max pooling at a third sub-layer with a filter size of 2×1, followed by a one-dimensional convolution with a stride of 2 with all filters at a fourth sub-layer, where each of the all filters at the fourth sub-layer is a 2×1 matrix, all as shown and described in connection with the student CNN model 602 of FIG. 6B. Of course, this is one example of a building block. Other examples of building blocks are within the scope of the disclosure.

In some aspects of the disclosure, the one or more processors 732 may include circuitry configured for various functions, including, for example, driving one or more output nodes of the student CNN model according to a detection by the student CNN model of an arc fault in the electrical current 728 passing through the current path 726, the one or more output nodes driven to: first value indicative of an absence of the detection of the arc fault in the electrical current 728 passing through the current path 726, or a second value indicative of the detection of the arc fault in the electrical current 728 passing through the current path 726. Any of the circuitry of the one or more processors 732 may be configured to execute respective instructions (e.g., software) stored on the computer-readable medium 738 or the one or more memories 734 to implement one or more functions described herein.

In some aspects of the disclosure, the one or more processors 732 may be configured to cause the solid state circuit breaker driver circuit 744 to, for example, drive the solid state circuit breaker 716 to an open switch state or a closed switch state. In the open switch state, the solid state circuit breaker 716 may impede the electrical current 728 (e.g., present a high impedance to the current) between the third terminal 718 and the fourth terminal 720. In the closed switch state, the solid state circuit breaker 716 may pass the electrical current 728 (e.g., presents a low impedance to the current) between the third terminal 718 and the fourth terminal 720. The solid state circuit breaker driver circuit 744 may be configured to execute solid state circuit breaker driver instructions (e.g., software) stored on the computer-readable medium 738 or the one or more memories 734 to implement one or more functions described herein.

The circuitry, the same as or similar to that described and illustrated in connection with FIG. 7, was fabricated and tested for accuracy. For real-time arc fault detection and circuit interruption experiments, the one or more processors 732 were configured as an STM32H743ZI2 MCU. The solid state circuit breaker driver circuit 744 was configured as Complex Programmable Logic Device (CPLD), The solid state circuit breaker 716 was configured as a silicon carbide (SiC) MOSFET. The STM32H743ZI2, featured a 32-bit Arm Cortex M7 processor running at 480 MHz, with 1 MB of RAM and 2 MB of flash memory. The STM32H743ZI2 was configured, at least in part, to operate as a student convolutional neural network (CNN) model that was pretrained using a knowledge distillation-based teacher-student approach.

When an arc fault was identified, the STM32H743ZI2 generated an “arc detect” signal, which was sent to the CPLD. The CPLD, coupled to the gate driver of the SSCB, triggered the SSCB to open, thereby interrupting the circuit and mitigating the fault.

The SSCB employed an N-channel MOSFET rated at 1200 V and 35 A, providing reliable performance under high-voltage and current conditions. Additionally, a Metal Oxide Varistor (MOV) rated at 660 V and 10 kA was used for transient voltage suppression, ensuring system protection during fault conditions. The real-time accuracy of the fabricated arc fault circuit interrupter apparatus was evaluated under diverse loading conditions to ensure its robustness and reliability across various operating scenarios.

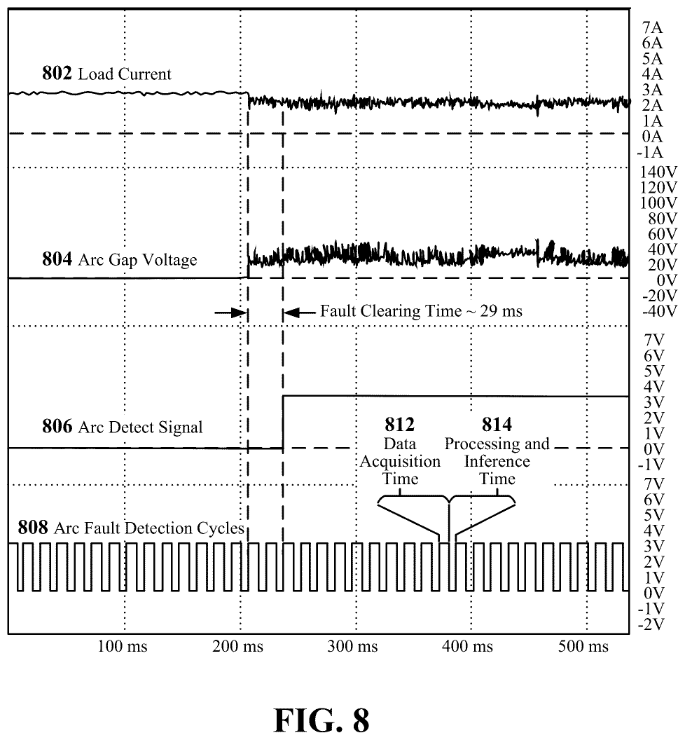

FIG. 8 is a graph depicting exemplary performance of an AFCI apparatus configured according to a 2-cycle arc fault detection approach according to some aspects of the disclosure. The parameters illustrated include load current 802, arc gap voltage 804, arc detect signal 806. Arc fault detection cycles 808 are shown for reference. In one exemplary arc fault detection cycle 808, a data acquisition (DAQ) time 812 and a processing and inference time 814 are depicted. Their placement in FIG. 8 is for convenience and not limitation. The data acquisition (DAQ) time 812 and the processing and inference time 814 need not be equal.

In the example test scenario, the load current was set to 3 A, and the voltage was 400 V. The data acquisition (DAQ) time 812 and the processing and inference time 814 are shown for reference. In this example, for illustrative and non-limiting purposes, the high arc fault detection cycles 808 signal represents the DAQ period (having a duration given by the data acquisition time 812), while the low arc fault detection cycles 808 signal indicates the processing and inference period (having a duration given by the processing and inference time 814). This setup enabled precise evaluation of accuracy by comparing detected results with ground truth data.

Online accuracy was assessed across various loading conditions, summarized in Table V. The test included a mix of arc and normal scenarios with currents ranging from 3 A to 8 A. A total of 1560 samples were tested online, of which 1531 were correctly detected, resulting in an overall detection accuracy of 98.14%. This high accuracy demonstrates the system's effectiveness in real-time arc fault detection and confirms its suitability for reliable operation in photovoltaic systems.

TABLE V
Online Accuracy Testing of Student CNN Model

| | | Accurate | |
|---|---|---|---|
| Current | Samples | Detection | Accuracy (%) |
| 3A (mixed) | 90 | 59 | 98.33 |
| 4A (normal) | 60 | 60 | 100 |
| 6A (mixed) | 600 | 596 | 99.33 |
| 6A (mixed) | 120 | 118 | 98.33 |
| 7A (mixed) | 120 | 115 | 95.83 |
| 8A (mixed) | 600 | 583 | 97.17 |
| Total= | 1560 | 1531 | 98.14 |

To enhance the reliability of the arc fault detection system, a strategy may be adopted where an arc fault lasting (continuously) for five consecutive arc fault detection cycles may be considered as one arc fault. This approach addresses issues associated with fast tripping due to detection within a single cycle, which can be prone to inaccuracies. By waiting for multiple consecutive cycles, the system ensures more robust detection of arc faults. In one example, a wait time of 5 consecutive arc fault detection cycles, during which an arc fault may be continuously detected, may be counted before tripping the breaker. The average fault clearing time of an AFCI apparatus utilizing a student convolutional neural network (CNN) model that was pretrained using a knowledge distillation-based teacher-student approach, such as that shown and described herein, was found to be between 95 to 106 ms. These values are provided by way of example and not limitation. This slight delay allows the system to capture the arc signature more accurately. Sometimes, the first cycle of an arc fault may go undetected due to partial capture of the arc signature, but the inclusion of subsequent cycles enhances overall detection accuracy. This approach significantly reduces false trips (e.g., false openings of the SSCB) and enhances the dependability of the arc fault detection apparatus in real-world applications, such as but not limited to photovoltaic applications.

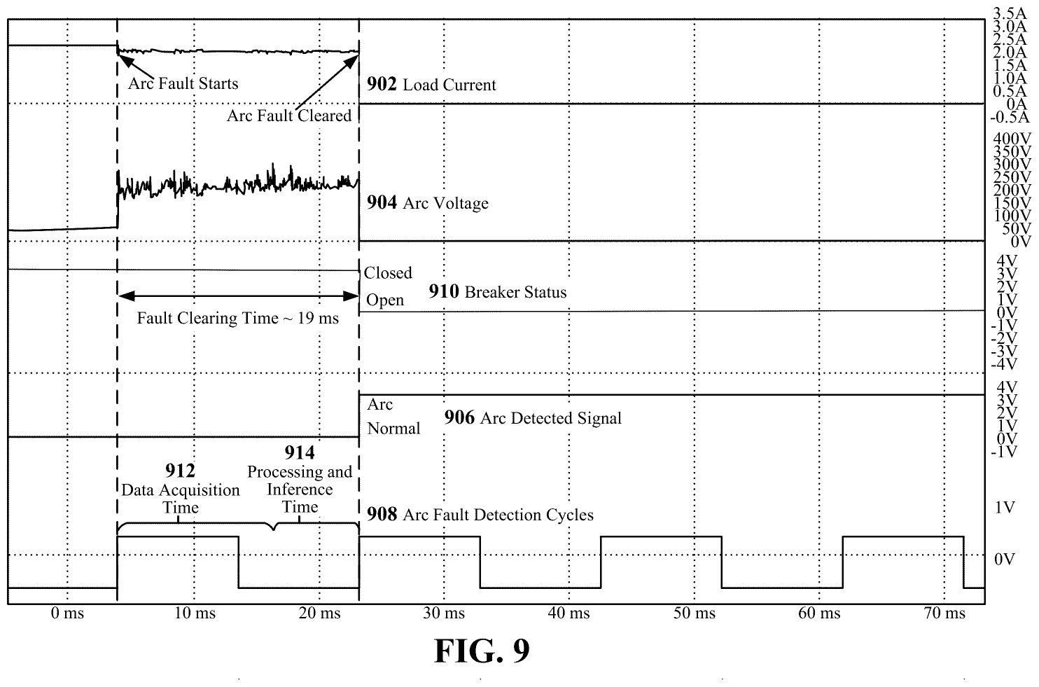

FIG. 9 is a graph depicting exemplary performance of an AFCI apparatus configured according to a 1-cycle arc fault detection approach according to some aspects of the disclosure. The parameters illustrated include load current 902, arc voltage 904, the arc detected signal 906, and breaker status 910. Arc fault detection cycles 908 are depicted for reference. In one arc fault detection cycle 908, a data acquisition (DAQ) time 912 and a processing and inference time 914 are depicted. Their placement in FIG. 9 is for convenience and not limitation. The data acquisition (DAQ) time 912 and the processing and inference time 814 need not be equal, as exemplified in FIG. 9.

The graph demonstrates fast circuit interruption using the solid-state circuit breaker. During the arcing period, the student CNN model continuously detected the fault, indicated by a sustained high arc detection signal, highlighting its reliability in identifying ongoing faults. The test conditions provided Imp=3 A, Vmp=400 V, and Voc=450 V. The arc fault is detected and the SSCB quickly interrupts the circuit (i.e., clears the arc fault). The fault clearing time was around 19 ms, effectively stopping the arcing and protecting the system. The incorporation of the SiC MOSFET in the SSCB enabled a rapid and reliable circuit-breaking mechanism upon arc fault detection, ensuring a fast response critical for minimizing damage and maintaining the safety of photovoltaic systems.

These real-time tests validate the effectiveness of a use of an AFCI apparatus that utilizes a student convolutional neural network (CNN) model that was pretrained using a knowledge distillation-based teacher-student approach, where the approach was deployed on the STM32H743ZI2 MCU alongside the SiC MOSFET-based SSCB for rapid arc fault detection and interruption. The system demonstrated a significant improvement over traditional methods, achieving a fault clearing time of just 19 ms with the AFCI-equipped setup. The STM32H743ZI2 MCU's affordability, sufficient computational capacity, and robust community support make it an excellent platform for real-time arc fault detection in photovoltaic systems (or any systems that include DC power sources, such as but not limited to battery applications), delivering enhanced safety and operational efficiency.

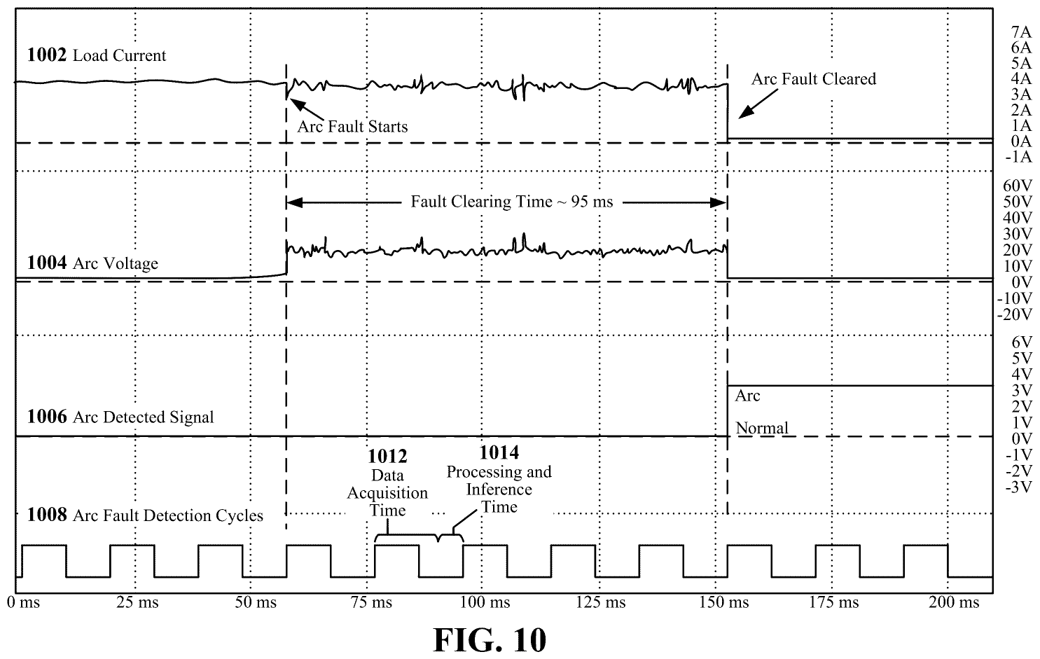

FIG. 10 is a graph depicting exemplary performance of an AFCI apparatus configured according to a 5-cycle arc fault detection approach according to some aspects of the disclosure. The parameters illustrated include load current 1002, voltage 1004, and arc detected signal 1006. Arc fault detection cycles 1008 are depicted for reference. In one arc fault detection cycle 1008, a data acquisition (DAQ) time 1012 and a processing and inference time 1014 are depicted. Their placement in FIG. 10 is for convenience and not limitation. The data acquisition (DAQ) time 1012 and the processing and inference time 1014 need not be equal, as exemplified in FIG. 10. In another example, not shown, instead of each of the five arc fault detection cycles including time for data acquisition and processing and inference, the AFCI may perform data acquisition for the first cycle (beginning when the arc fault starts), and detect an arc fault within the acquired data, the AFCI may then perform data acquisition for the second cycle and detect an arc fault within the acquired data, the AFCI may then perform data acquisition for the third cycle and detect an arc fault within the acquired data, the AFCI may then perform data acquisition for the fourth cycle and detect an arc fault within the acquired data, the AFCI may then perform data acquisition for the fifth cycle and detect an arc fault within the acquired data and then, within the fifth cycle, the AFCI may perform processing and inference operations.

The graph of FIG. 10 demonstrates fast circuit interruption using the solid-state circuit breaker. During the arcing period, the student CNN model continuously detected the fault for the entirety of 5 arc fault detection cycles 908. The results show that the arc fault is cleared within about 95 ms, confirming the system's ability to respond quickly and accurately. This method is less likely to result in false tripping, thereby enhancing the overall safety and reliability of the photovoltaic system.

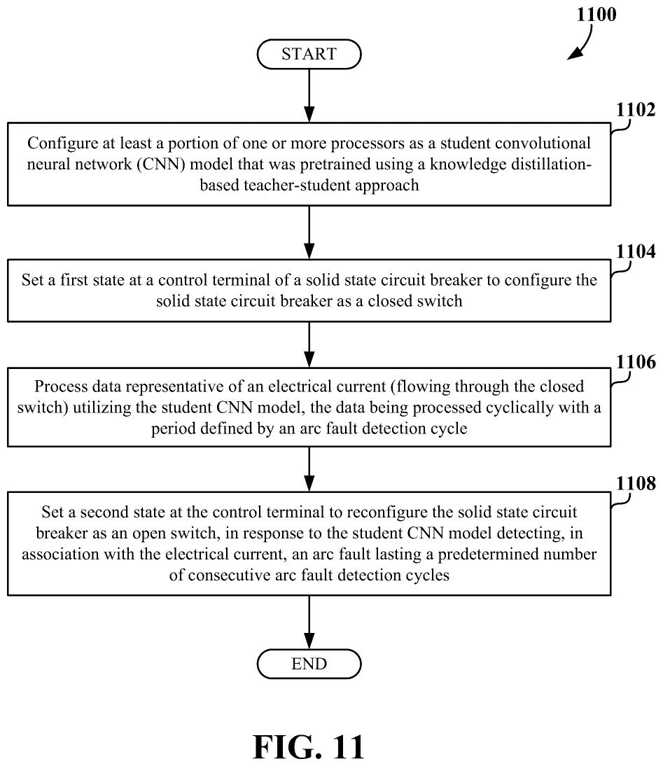

FIG. 11 is a flow chart illustrating an example process 1100 (e.g., a method) at an AFCI apparatus in accordance with some aspects of the disclosure. As described below, some or all illustrated features may be omitted in a particular implementation within the scope of the present disclosure, and some illustrated features may not be required for implementation of all embodiments. In some examples, the process 1100 may be carried out by the AFCI apparatus 704, as shown and described in connection with FIG. 7. The AFCI apparatus 704 may be similar to, for example, any of the AFCI apparatus or portions thereof as shown and described in connection with FIGS. 1, 2, 3 and/or 7. In some examples, the process 1100 may be carried out by any suitable apparatus or means for carrying out the functions or algorithm described below.

For example, the AFCI apparatus may include a first terminal, a second terminal distal from the first terminal, a solid state circuit breaker having a third terminal coupled to the first terminal, a fourth terminal coupled to the second terminal, and a control input (e.g., a terminal, a connector). The solid state circuit breaker may be selectively configured as a closed switch or an open switch based on a first state of the control input or a second state of the control input, respectively. According to some examples, the solid state circuit breaker may be a solid state circuit breaker fabricated as a metal-oxide-semiconductor field-effect transistor (MOSFET) configured as a single pole single throw switch. In general, the solid state circuit breaker may be any circuit configured as a controllable electronic switch able to handle a current expected to pass through the AFCI. According to some aspects, the solid state circuit breaker may present a high impedance to current in response to the solid state circuit breaker entering an unbiased state. The high impedance provides a failsafe open-switch-state configuration of the solid state circuit breaker.

The AFCI apparatus may also include a current sensor coupled to a current path coupling the first terminal and the second terminal and configured to sense an electrical current flowing on the current path (or, when in a closed state, flowing between the third terminal and the fourth terminal of the solid state circuit breaker. The AFCI apparatus may also include one or more processors coupled to the control input and the current sensor, as well as one or more memories coupled to the one or more processors. According to some aspects, the one or more processors may be configured to execute instructions stored on the one or more memories that, when executed by the one or more processors, cause the one or more processors to perform a process such as the process 1100 as shown and described in connection with FIG. 11 and as explained below.

At block 1102, the AFCI apparatus may configure at least a portion of one or more processors as a student convolutional neural network (CNN) model that was pretrained using a knowledge distillation-based teacher-student approach. According to some aspects, the student CNN model may be implemented as a plurality of building blocks, each building block of the plurality of building blocks may be implemented in the order recited as: a one-dimensional pointwise convolution with one-half of all filters at a first sub-layer, wherein each of the one-half of all filters at the first sub-layer is a 1×1 matrix; a one-dimensional depthwise convolution with one-half of all filters at a second sub-layer, wherein each of the one-half of all filters at the second sub-layer is 5×1 matrix; a max pooling at a third sub-layer with a filter size of 2×1; and a one-dimensional convolution with a stride of two with all filters at a fourth sub-layer, wherein each of the all filters at the fourth sub-layer is a 2×1 matrix. For example, the one or more processors 732, as shown and described in connection with FIG. 7, may provide a means for configuring at least a portion of one or more processors as a student convolutional neural network (CNN) model that was pretrained using a knowledge distillation-based teacher-student approach.

At block 1104, the AFCI apparatus may set the first state at the control input to configure the solid state circuit breaker as the closed switch. In other words, the AFCI apparatus may cause a first control signal to be set to the first state and be applied to the control input of the solid state circuit breaker to configure the solid state circuit breaker as the closed switch. For example, the solid state circuit breaker driver circuit 744, as shown and described in connection with FIG. 7, may provide a means for setting the first state at the control input to configure the solid state circuit breaker as the closed switch.

At block 1106, the AFCI apparatus may process data representative of the electrical current utilizing the student CNN model, the data being processed cyclically with a period defined by an arc fault detection cycle. For example, the one or more processors 732, in combination with the current sensor 724 and, if present, the current sensor interface/data preprocessing circuit/apparatus 731 may provide the means for processing data representative of the electrical current utilizing the student CNN model, the data being processed cyclically with a period defined by an arc fault detection cycle.

At block 1108, the AFCI apparatus may set the second state at the control input to reconfigure the solid state circuit breaker as the open switch, in response to the student CNN model detecting, in association with the electrical current, an arc fault lasting a predetermined number of consecutive arc fault detection cycles. In other words, the AFCI apparatus may cause a second control signal to set at a value representative of the second state in order to reconfigure the solid state circuit breaker as an open switch, in response to the student CNN model detecting an arc fault lasting a predetermined number of consecutive arc fault detection cycles. In some examples, the predetermined number may be configurable. In some examples, a reliability of arc fault detections increases as the predetermined number increases. In some examples, the predetermined number may be a number between 2 and 10, inclusive, or more specifically between 4 and 7, inclusive. The preceding ranges of numbers are non-limiting. It is within the scope of this disclosure to have the predetermined number be 1. For example, the solid state circuit breaker driver circuit 744, in combination with the one or more processors 732, as shown and described in connection with FIG. 7, may provide a means for setting the second state at the control input to reconfigure the solid state circuit breaker as the open switch, in response to the student CNN model detecting, in association with the electrical current, an arc fault lasting a predetermined number of consecutive arc fault detection cycles.

According to some aspects, a reliability of the detecting the arc fault increases as the predetermined number increases. In some examples, the predetermined number may be a number between 2 and 10, inclusive, or more specifically between 4 and 7, inclusive. The preceding ranges of numbers are non-limiting. According to some aspects, the detecting the arc fault may be continuous during the predetermined number of consecutive arc fault detection cycles. According to some aspects, the AFCI apparatus may maintain the reconfiguration of the solid state circuit breaker as the open switch until receipt of a user authorization to again configure the solid state circuit breaker as the closed switch For example, the solid state circuit breaker driver circuit 744, in combination with the one or more processors 732, as shown and described in connection with FIG. 7, may provide a means for reconfiguring the solid state circuit breaker as an open switch in response to the student CNN model detecting, in association with the electrical current, an arc fault lasting a predetermined number of consecutive arc fault detection cycles.

Thereafter, the process 1100 may end.

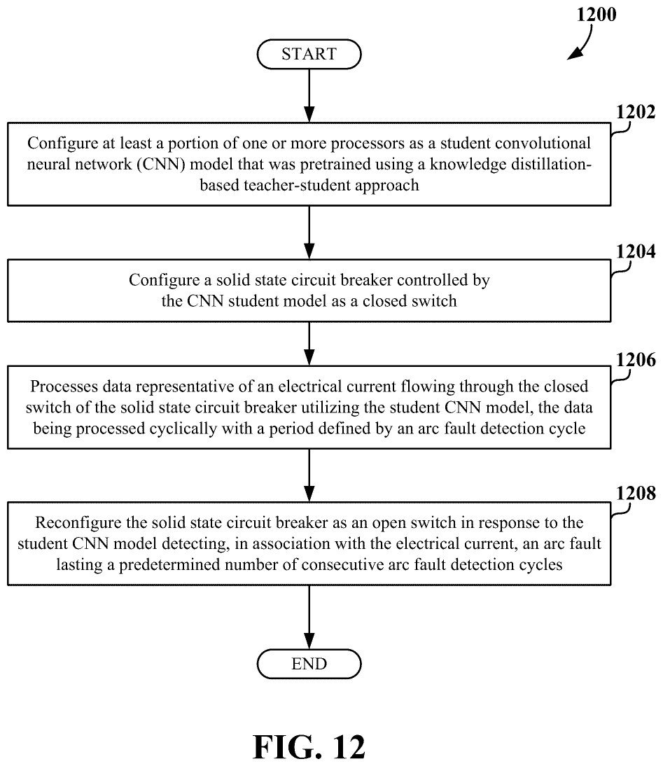

FIG. 12 is a flow chart illustrating an example process 1200 (e.g., a method) at an AFCI apparatus in accordance with some aspects of the disclosure. As described below, some or all illustrated features may be omitted in a particular implementation within the scope of the present disclosure, and some illustrated features may not be required for implementation of all embodiments. In some examples, the process 1200 may be carried out by the AFCI apparatus 704, as shown and described in connection with FIG. 7. The AFCI apparatus 704 may be similar to, for example, any of the AFCI apparatus or portions thereof as shown and described in connection with FIGS. 1, 2, 3 and/or 7. In some examples, the process 1200 may be carried out by any suitable apparatus or means for carrying out the functions or algorithm described below.

At block 1202, the AFCI apparatus may configure at least a portion of one or more processors as a student convolutional neural network (CNN) model that was pretrained using a knowledge distillation-based teacher-student approach. According to some aspects, the student CNN model may be implemented as a plurality of building blocks, each building block of the plurality of building blocks may be implemented, in the order recited, as: a one-dimensional pointwise convolution with one-half of all filters at a first sub-layer, wherein each of the one-half of all filters at the first sub-layer is a 1×1 matrix; a one-dimensional depthwise convolution with one-half of all filters at a second sub-layer, wherein each of the one-half of all filters at the second sub-layer is 5×1 matrix; a max pooling at a third sub-layer with a filter size of 2×1; and a one-dimensional convolution with a stride of two with all filters at a fourth sub-layer, wherein each of the all filters at the fourth sub-layer is a 2×1 matrix. For example, the one or more processors 732, as shown and described in connection with FIG. 7, may provide a means for configuring at least a portion of one or more processors as a student convolutional neural network (CNN) model that was pretrained using a knowledge distillation-based teacher-student approach.

At block 1204, the AFCI apparatus may configure a solid state circuit breaker controlled by the student CNN model as a closed switch. In some examples, the solid state circuit breaker may be a metal-oxide-semiconductor field-effect transistor (MOSFET) configured as a single pole single throw switch. In some examples, the solid state circuit breaker may be any circuit configured as a controllable electronic switch able to handle a current expected to pass through the AFCI. According to some aspects, the solid state circuit breaker may present a high impedance to current in response to the solid state circuit breaker entering an unbiased state. The high impedance provides a failsafe open-switch-state configuration of the solid state circuit breaker. For example, the one or more processors 732, in combination with the solid state circuit breaker driver circuit 744, as shown and described in connection with FIG. 7, may provide a means for configuring a solid state circuit breaker controlled by the student CNN model as a closed switch.

At block 1206, the AFCI apparatus may process data representative of an electrical current flowing through the closed switch of the solid state circuit breaker utilizing the student CNN model, the data being processed cyclically with a period defined by an arc fault detection cycle. For example, the one or more processors 732, in combination with the current sensor 724 and, if present, the current sensor interface/data preprocessing circuit/apparatus 731 may provide the means for processing data representative of an electrical current flowing through the closed switch of the solid state circuit breaker utilizing the student CNN model, the data being processed cyclically with a period defined by an arc fault detection cycle.

At block 1208, the AFCI apparatus may reconfigure the solid state circuit breaker as an open switch in response to the student CNN model detecting, in association with the electrical current, an arc fault lasting a predetermined number of consecutive arc fault detection cycles. In some examples, the predetermined number is configurable. That is, the predetermined number may be configured to the processing system, such as the processing system 730 as shown and described in connection with FIG. 7. The processing system may store the configured predetermined number in one or more memories or on a computer-readable medium such as the one or more memories 734 or the computer-readable medium 738 as shown and described in connection with FIG. 7.

According to some aspects, a reliability of the detecting the arc fault increases as the predetermined number increases. In some examples, the predetermined number may be a number between 2 and 10, inclusive, or more specifically between 4 and 7, inclusive. The preceding ranges of numbers are non-limiting. According to some aspects, the detecting the arc fault may be continuous during the predetermined number of consecutive arc fault detection cycles. According to some aspects, the AFCI apparatus may maintain the reconfiguration of the solid state circuit breaker as the open switch until receipt of a user authorization to again configure the solid state circuit breaker as the closed switch For example, the solid state circuit breaker driver circuit 744, in combination with the one or more processors 732, as shown and described in connection with FIG. 7, may provide a means for reconfiguring the solid state circuit breaker as an open switch in response to the student CNN model detecting, in association with the electrical current, an arc fault lasting a predetermined number of consecutive arc fault detection cycles.

Thereafter, the process 1200 may end.

Of course, in the above examples, the circuitry included in the one or more processors of the AFCI apparatus 704 of FIG. 7, is merely provided as an example. Other means for carrying out the described processes or functions may be included within various aspects of the present disclosure, including but not limited to the instructions stored in the computer-readable medium 738 and/or the one or more memories 734 of the AFCI apparatus 704 of FIG. 7, or any other suitable apparatus or means described in any one of the FIGS. 1, 2, 3, 5, 6A, 6B, and/or 7 utilizing, for example, the processes and/or algorithms described herein in relation to FIGS. 1-12.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features, and/or functions illustrated in FIGS. 1-12 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

As used herein, the term “determine” or “determining” encompasses a wide variety of actions and, therefore, “determining” can include calculating, computing, processing, deriving, investigating, looking up (such as via looking up in a table, a database, or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing, and other similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Similarly, a phrase referring to A “and/or” B may include A only, B only, or a combination of A and B.

As used herein, “based on” is intended to be interpreted in the inclusive sense, unless otherwise explicitly indicated. For example, “based on” may be used interchangeably with “based at least in part on,” “associated with,” or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples can also be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus, comprising:
a first terminal;
a second terminal distal from the first terminal;
a solid state circuit breaker having a third terminal coupled to the first terminal, and a fourth terminal coupled to the second terminal, the solid state circuit breaker selectively configured as a closed switch or an open switch;
a current sensor coupled to a current path coupling the first terminal and the second terminal and configured to sense an electrical current flowing on the current path while the solid state circuit breaker is configured as the closed switch; and
a student convolutional neural network (CNN) model that was pretrained using a knowledge distillation-based teacher-student approach, the student CNN model coupled to the solid state circuit breaker and the current sensor and configured to process data representative of the electrical current, the data being processed cyclically with a period defined by an arc fault detection cycle,
wherein, in response to the student CNN model detecting, in association with the electrical current, an arc fault lasting a predetermined number of consecutive arc fault detection cycles, the solid state circuit breaker is reconfigured as the open switch.

2. The apparatus of claim 1, wherein the solid state circuit breaker comprises a metal-oxide-semiconductor field-effect transistor (MOSFET) configured as a single pole single throw switch.

3. The apparatus of claim 1, wherein in an unbiased state, the solid state circuit breaker presents a high impedance between the third terminal and the fourth terminal, providing a failsafe open-switch-state at the solid state circuit breaker.

4. The apparatus of claim 1, wherein the predetermined number is configurable.

5. The apparatus of claim 1, wherein a reliability of arc fault detections increases as the predetermined number increases.

6. The apparatus of claim 1, wherein the predetermined number is a number between 2 and 10, inclusive, or more specifically between 4 and 7, inclusive.

7. The apparatus of claim 1, wherein the detecting of the arc fault is continuous during the predetermined number of consecutive arc fault detection cycles.

8. The apparatus of claim 1, wherein after the solid state circuit breaker is reconfigured as the open switch, the solid state circuit breaker is maintained as the open switch until a user authorizes again reconfiguring the solid state circuit breaker as the closed switch.

9. The apparatus of claim 1, where the student CNN model is implemented as a plurality of building blocks, respective building blocks being implemented as:
a one-dimensional pointwise convolution with one-half of all filters at a first sub-layer, wherein each of the one-half of all filters at the first sub-layer is a 1×1 matrix;
a one-dimensional depthwise convolution with one-half of all filters at a second sub-layer, wherein each of the one-half of all filters at the second sub-layer is 5×1 matrix;
a max pooling at a third sub-layer with a filter size of 2×1; and
a one-dimensional convolution with a stride of two with all filters at a fourth sub-layer, wherein each of the all filters at the fourth sub-layer is a 2×1 matrix.

10. A method, comprising:
configuring at least a portion of one or more processors as a student convolutional neural network (CNN) model that was pretrained using a knowledge distillation-based teacher-student approach;
configuring a solid state circuit breaker controlled by the student CNN model as a closed switch;
processing data representative of an electrical current flowing through the closed switch of the solid state circuit breaker utilizing the student CNN model, the data being processed cyclically with a period defined by an arc fault detection cycle; and
reconfiguring the solid state circuit breaker as an open switch in response to the student CNN model detecting, in association with the electrical current, an arc fault lasting a predetermined number of consecutive arc fault detection cycles.

11. The method of claim 10, wherein the solid state circuit breaker comprises a metal-oxide-semiconductor field-effect transistor (MOSFET) configured as a single pole single throw switch.

12. The method of claim 10, further comprising:
presenting, by the solid state circuit breaker, a high impedance to current in response to the solid state circuit breaker entering an unbiased state, wherein the high impedance provides a failsafe open-switch-state configuration of the solid state circuit breaker.

13. The method of claim 10, wherein the predetermined number is configurable.

14. The method of claim 10, wherein a reliability of the detecting the arc fault increases as the predetermined number increases.

15. The method of claim 10, wherein the predetermined number is a number between 2 and 10, inclusive, or more specifically between 4 and 7, inclusive.

16. The apparatus of claim 1, wherein the detecting the arc fault is continuous during the predetermined number of consecutive arc fault detection cycles.

17. The method of claim 10, further comprising:
maintaining the reconfiguration of the solid state circuit breaker as the open switch until receipt of a user authorization to again configure the solid state circuit breaker as the closed switch.

18. The method of claim 10, further comprising:
implementing the student CNN model as a plurality of building blocks, each building block of the plurality of building blocks implemented as:
a one-dimensional pointwise convolution with one-half of all filters at a first sub-layer, wherein each of the one-half of all filters at the first sub-layer is a 1×1 matrix;
a one-dimensional depthwise convolution with one-half of all filters at a second sub-layer, wherein each of the one-half of all filters at the second sub-layer is 5×1 matrix;
a max pooling at a third sub-layer with a filter size of 2×1; and
a one-dimensional convolution with a stride of two with all filters at a fourth sub-layer, wherein each of the all filters at the fourth sub-layer is a 2×1 matrix.
